(19) United States
(12) Patent Application Publication
(10) Pub. No.: US 2026/0172835 A1
(43) Pub. Date: Jun. 18, 2026

(54) METHODS OF OPERATING A UICC AND A NETWORK NODE, A UICC AND A NETWORK NODE IMPLEMENTING THE SAME

(71) Applicant: Telefonaktiebolaget LM Ericsson (publ), Stockholm (SE)

(72) Inventors: Santeri PAAVOLAINEN, Masala (SE); Patrik SALMELA, Espoo (FI); Mukesh THAKUR, Espoo (FI); Niklas LINDSKOG, Lund (SE)

(21) Appl. No.: 19/107,172

(22) PCT Filed: Sep. 1, 2022
(86) PCT No.: PCT/IB2022/058199

§ 371 Date: Feb. 27, 2025

(51) Int. Cl. H04W 12/79; H04W 12/069

(52) U.S. Cl. CPC H04W 12/79; H04W 12/069

(57) ABSTRACT

According to an aspect, there is provided a method of operating a universal integrated circuit card, UICC, (56) in a host mobile equipment, ME, (4). The method comprises measuring (1002) one or more characteristics of the host ME (4); determining (1004) if the characteristic measurements for the host ME (4) are consistent with a first ME fingerprint corresponding to a first ME; and performing (1006) a first action if the characteristic measurements for the host ME (4) are inconsistent with the first ME fingerprint.

### TECHNICAL FIELD

This disclosure relates to a universal integrated circuit card (UICC) that can be present in a mobile equipment (ME), and in particular to methods of operating a UICC and a network node in a communication network, and computer program products and a UICC and network node implementing the same.

### BACKGROUND

For a consumer, a mobile phone may appear as a monolithic object, where the subscription, Subscriber Identity Module (SIM), phone, and the network act as a cohesive whole with a singular purpose. There are, however, several different components within this system that act in different roles and may sometimes be considered adversarial to each other, as shown in FIG. 1. The mobile phone 2 in FIG. 1 is internally logically composed of mobile equipment (ME) 4 (corresponding to the physical phone) and a SIM 6 that enables the ME 4 to represent the subscriber to the network 8. The phone 2 is the unit that the consumer commonly sees and interacts with (often referred as “user equipment” (UE)). The mobile equipment 4 is usually purchased by the end-user, but this does not represent the “phone” (in its intended purpose, as a communication device) as an end-user sees it, as the ME 4 can only access the network if the network operator has provided a subscription. This subscription is made accessible to the ME 4 via the SIM 6. Both the ME 4 and the SIM 6 comprise respective hardware and software portions, of which select components are shown in FIG. 1.

In particular, for consumers, the mobile phone 2 and the subscription may appear as inseparable, but logically—and almost always physically—these are separate functions. The mobile phone, or more accurately, the mobile equipment (ME) 4 is the device which contains the radio modem 10, user interface (e.g. comprising a display, keypad, touchscreen, etc., or none of these if the mobile phone 2 is an embedded Internet of Things (IoT) device), power supply, etc.

Typically, the ME 4 contains a system-on-a-chip (SoC) module containing not only the main central processing unit (CPU) 12 that the operating system (OS) 14 runs on, but also the modem circuitry 10 for offloading radio network protocol processing, etc. The modem 10 usually also handles communication with the SIM 6, which in 5^{th} Generation (5G) terminology is called the UICC (universal integrated circuit card). For clarity, FIG. 1 distinguishes the low-level electrical and logical communication between the modem 10 and the SIM 6 that occurs via UICC PHY 16, the physical interface module.

The SIM 6 is similarly comprised of hardware 18 (as defined in 3^{rd} Generation Partnership Project (3GPP) TS 31.101 v17.0.0 (2022 March) “UICC-terminal interface; Physical and logical characteristics (Release 17)”), including an ETSI TS 102 221-compliant (i.e. compliant with: ETSI TS 102 221 v17.0.0 (2021 October) “Smart Cards; UICC-Terminal interface; Physical and logical characteristics (Release 17)”) signalling interface 20 (102 221 PHY) and optionally an ETSI TS 102 600-compliant (i.e. compliant with: ETSI TS 102 600 v10.1.0 (2020 September) “Smart Cards; UICC-Terminal interface; Characteristics of the USB interface (Release 10)”) Universal Serial Bus (USB) interface 22 (Inter-Chip USB PHY) and a CPU 24. The CPU 24 on the SIM 6 runs a custom operating system provided by the card manufacturer which is referred to as Card OS 26. The operating system 26 can host multiple applications running either sequentially or concurrently, although for the purposes of the present disclosure, only the Universal Subscriber Identity Module (USIM) application 28 as defined in 3GPP TS 31.102 v17.4.0 (2021 December) “Characteristics of the Universal Subscriber Identity Module (USIM) application (Release 17)” is relevant.

It should be noted that the module providing subscription information for the ME 4 is commonly called “SIM” 6. As used herein, SIM refers to the overall capability of providing subscriber information to the phone 2, where the physical adaptation of the SIM 6 may be an UICC, an embedded UICC (eUICC), or an integrated UICC (iUICC). The differences between these types of UICC are described more in detail below, but for the most part, the differences between these at a capability level is not significant. While these types of UICC differ significantly in terms of the provisioning model used, the provisioning of subscriber information to the UICC is not relevant to the present disclosure.

### Mobile Equipment and Subscriptions

For the ME 4 to be able to place all but emergency calls, it needs to register itself to the mobile network 8 (either the home network, or a visited network). Since the introduction of the Global System for Mobile (GSM) communications, the authority to provide the necessary credentials and information for the ME 4 to register to the network have been separated to a SIM card 6 (UICC), and, more recently, to an embedded (eSIM), e.g. an eUICC, and an integrated SIM (iSIM), e.g. iUICC. The SIM 6 is provided and provisioned by the home network operator, establishing a trust relationship between the SIM 6 and the operator. The operator is in control of what goes into the SIM card 6, including any necessary credentials it can use to authenticate itself to the network 8.

Technically, a SIM card 6 is physically a UICC device, as specified in ETSI TS 102 221 mentioned above, i.e. a generic smart card. What makes a smart card (UICC) specifically a SIM 6 is the fact that it contains and runs the USIM application 28 as specified in 3GPP TS 31.102 mentioned above (and many subsequent amendments and extensions). It is the USIM application 28 that has access to the operator-supplied authentication credentials, such as its subscriber identifier (International Mobile Subscriber Identity (IMSI)) and a shared secret K that is shared between the SIM 6 and operator 8.

Historically a SIM 6 has been a card, with the first phones using a full-size card, but with requirements of weight and space use on MEs, the card size has been significantly reduced, and commonly a so-called “nano SIM” is now used, which is as small as feasible while maintaining some level of physical backward compatibility. A newer approach is to use eSIMs or iSIMs which are provisioned over the air, i.e., digitally, without a physical SIM card being given to the customer. These eSIMs and iSIMs either have a separate eUICC discrete chip that runs a USIM application, as an embedded IP core within a SoC, or as a fully software-based application running in a trusted execution environment (TEE) within the CPU 12 of the ME 4.

### ME and UICC Interaction

ETSI TS 102 221 mentioned above defines the terminal (i.e. the ME 4 for mobile networks) and UICC interaction on the physical, electrical, and logical layers. FIG. 2 illustrates the different protocol layers in a terminal and UICC as set out in ETSI TS 102 221.

When a SIM 6 is either inserted into an ME 4, or the ME 4 is accessing the UICC after a reset (of the ME 4 or the UICC), the ME 4 will start by establishing the voltage of the physical layer, as UICCs and MEs 4 can support different power and signalling voltage levels. This is followed by further establishment of communication parameters for the data link, transport and Card Application Toolkit (CAT) layers, after which the ME 4 can establish communication with the USIM application 28, including identifying the capabilities it supports (such as USIM services defined in a Elementary Files USIM Service Table (EF_{UST}) file in the USIM application directory (as described in 3GPP TS 31.102 mentioned above)). This communication is quite complex due to the need for MEs 4 to support multiple generations of SIMs 6 (physical and electrical characteristics) and USIM applications (3^{rd} Generation (3G)/4^{th} Generation (4G)/5^{th} Generation (5G), and various optional features) as well as for the USIM to support MEs 4 with varying capabilities (modems, speeds, power saving etc.).

While the UICC protocol is logically a request-response protocol driven entirely by the terminal (ME 4), this has been extended to support proactive UICCs where the ME 4 periodically polls the UICC to see if the UICC has a need to issue commands to the ME 4. This allows the UICC to also initiate commands on the ME side, even while the underlying transport protocol is inherently driven by the ME only.

### Identifying ME and SIM

There may be various valid reasons for an ME 4 and SIM 6 to mutually identify each other, such as carrier locking (i.e. a ME 4 working only with a SIM 6 from one operator) or phone locking (i.e. a SIM 6 working only for a specific ME 4). This is facilitated by the ME 4 being able to retrieve the subscriber identifier (e.g. IMSI) from the SIM 6 via the EF_{IMSI} (elementary file) in the USIM application directory (as described in 3GPP TS 31.102). Correspondingly, the USIM application 28 can retrieve the device identifier (e.g. International Mobile Equipment Identity (IMEI)) using the LOCAL INFORMATION proactive UICC command, as described in 3GPP TS 31.111 v17.2.0 (2021 December) “Universal Subscriber Identity Module (USIM) Application Toolkit (USAT) (Release 17)”.

Both IMSI and IMEI have the shortcoming of being unauthenticated—there is no mechanism for the ME 4 to determine that the SIM's IMSI has really been provisioned for this particular card by using, for example, a challenge-response protocol against an asymmetric key pair certified by the operator “owning” the IMSI. Similarly, the IMEI of the device is given to the USIM application 28 “as-is”, without the USIM being able to determine whether the IMEI corresponds to a real physical device, or to the device it is communicating with. For example, it is possible for an adversary to perform a relay attack so that either or both of the ME 4 and USIM 28 think they are in communication with another ME device 4 or SIM 6. Similarly, an attacker with sufficient resources can fully emulate or simulate either the SIM 6 or the ME 4.

The standards (e.g. as described in 3GPP TS 42.009 v4.1.0 (2006 June) “Technical Specification Group Services and System Aspects; Security aspects (Release 4)”) offer only a relatively weak protection in asserting that:
The IMSI is stored securely within the SIM 6.
The IMEI shall not be changed after the ME's final production process. It shall resist tampering, i.e., manipulation and change, by any means (e.g., physical, electrical and software).

Typically, a SIM 6 requires the user to enter a personal identification number (PIN) to unlock it, but this is for providing a “something-you-know” authentication from the user to the SIM 6. It does not establish or prove the validity of the device (such as IMEI) to the SIM 6.

eSIM and iSIMs

While eSIMs (eUICC) and iSIMs (iUICC) are provisioned remotely and effectively are “only” provisioning digital (profile) information sent from the operator to the device, they share a lot of similarities with a physical UICC. Even 3GPP TS 31.101 mentioned above acknowledges that a USIM may interact with the ME 4 over a non “SIM form factor” interface (as defined in TS 102 221 mentioned above). FIG. 3 shows an example of a USIM application communicating with a terminal over a non-UICC interface, which is taken from 3GPP TS 31.101, where the non-UICC interface is a USB interface.

The ME↔eSIM/iSIM interface carries a lot of the same legacy, allowing minimal porting requirements from UICC-based SIM interfaces to an eUICC/iUICC based eSIM/iSIM for the ME 4. Hence, the eSIM/iSIM is accessed using the same UICC-based directory and file structure, uses the same USIM commands, and enables the same proactive UICC interface as a physical UICC/SIM interface. Therefore, while the physical and electrical characteristics of an eSIM/iSIM may differ from physical SIMs, they are, for all the relevant parts, identical for the higher layers.

### Physically Unclonable Functions (PUFs)

PUFs are used to create a unique response by using implicit or explicit randomness. To create a PUF response, the PUF is fed a challenge, usually a binary string of a fixed length. This response can be used for cryptographic or device identity purposes.

The benefit of using a PUF is that two identical PUF implementations on different devices/components may result in different responses when fed the same challenges. Hence, the “unclonable” in Physically Unclonable Function.

Implicit randomness is extracted from unpredictable manufacturing differences, e.g., in semiconductor devices which can be exploited to create a device-unique response. Explicit randomness on the other hand means that the introduction of randomness requires extra steps during manufacturing, or at a later stage, e.g., at packaging.

A PUF can consist of one or several subfunctions, each contributing to a part of the PUF response. Examples of subfunctions can be:
Ring-oscillators, an uneven number of signal inverters in a ring which uses gate delay propagation as a source of randomness. The response is a comparison between two or more ring-oscillators where the number of oscillations at a given point is measured. The result can be, for example, the identifier of the fastest/slowest ring oscillator.
Uninitialized Static Random Access Memory (SRAM) memory cells, which have two possible states (0 and 1). Prior to power up, the cell is in neither state. At powerup, the cell stabilizes in one of the two states. The response is the entered state.
A transmission (TX) line, e.g. a coaxial cable. Using the intrinsic impedance inhomogeneity pattern of any TX-Line, i.e. the variation of characteristic impedance over distance, the TX-Line can be identified with a high verification accuracy. The PUF responses can be extracted using either frequency domain reflectometry (FDR) or time domain reflectometry (TDR) methods.
A radio transmitter, as described in “RF-PUF: Enhancing IoT Security through Authentication of Wireless Nodes using In-situ Machine Learning” (https://arxiv.org/abs/1805.01374), where a radio receiver is able to extract transmitter-unique features from transmitted signals. Such features include frequency offset, I-Q features (amplitude and phase mismatch) as well as channel features (attenuation, distortion and Doppler shift).

The PUF response can be used to create a unique device identity or a device unique key, without having to store the key in, e.g. a Battery Backed RAM (BBRAM) or One Time Programmable (OTP) memory. Hence, it is much harder for an attacker to steal a key from a device using a PUF, as the key is never stored on device.

There are several types of PUFs, but they can generally be divided into two different categories, capable of few challenge-response pairs (CRPs) and those have a large set of CRPs. The latter can produce several different responses by using different challenges as input. The former only allows one or a few challenges. If the PUF only accepts a single challenge, the challenge may be hard-coded or omitted.

Most PUF types additionally require error correcting codes (often denoted as helper data) to function properly, i.e. to increase the possibility of recreating the same response given the same challenge.

### Existing Techniques

Some existing techniques check the environment in which hardware is operating. These can include, for example, boot security solutions including measured boot, trusted boot, and secure boot.

Measured boot includes measuring (e.g. hashing) every component which is loaded on the system and storing the result in a boot register. Such registers are usually extendable rather than directly writable, e.g., as Rₜ₊₁=OWF (Rₜ∥ArgumentOfExtend). The result can either be a hash chain, each individual hash, or a combination of the two.

Trusted boot is basically measured boot but with validation of the values during the boot process. That is, the device itself knows what measurements to expect and, if they differ, the device does not boot, or enters a secure state.

Secure boot requires the use of cryptographic signatures which has to be rooted in a so-called root-of-trust (RoT). This is usually a fused key, where the key may either be unique for each device or a vendor key reused for many devices.

PUFs which utilise transmission characteristics as a “function” are described in, for example, “Transmission Identification via Impedance Inhomogeneity Pattern” Line (https://ieeexplore.ieee.org/abstract/document/8732652), and in “RF-PUF: Enhancing IoT Security through Authentication of Wireless Nodes using In-situ Machine Learning”. The solutions describe authentication of devices/components using wired and wireless transmission characteristics properties respectively. Wired channel properties include e.g. impendence inhomogeneity patterns and wireless channel properties include e.g. frequency offset and phase mismatch.

US 2021/0314365 describes a method for attesting hardware. The hardware is divided into two layers, where a first layer attests the characteristics of a second layer. The characteristics of the second hardware layer are described by firmware, read-only memory, storage memory, fuses, straps, softstraps, or electronic fuses. Once the second hardware layer is attested, it may be utilised to be attest a software layer.

### SUMMARY

The overall security landscape for mobile communication has improved over time. For example, 5G has brought improvements to the security and privacy of the ME to network authentication, and the over-the-air (OTA) remote provisioning of eSIM/iSIM is also secure against third-party and man-in-the-middle tampering.

While the ME↔USIM interface has been expanded to enable new functionality on advanced networks, the underlying assumption has not changed, i.e. that both the ME and USIM assume the other party is honest with the other side, and that no entity can inject itself between these two. This may be a valid assumption for threat models where the target is monolithic, i.e. where the ME and SIM are inseparable.

However, the use of mobile subscriptions for other purposes has increased, such as using the subscription as an identifier (in WhatsApp, Telegram, and other services where the user's whole online identity is attached to the subscriber's phone number (although it should be noted that the phone number is not directly related to the SIM card's IMSI, but for most use cases a temporary equality between the two can be assumed). Another use of mobile subscriptions is the capability of the user to receive Short Message Service (SMS) messages (i.e. reachable by their subscription) as a form of multi-factor authentication (MFA). Against these kinds of attacks, the assumption that the SIM cannot be surreptitiously removed and inserted into another device is no longer a safe assumption.

This also brings forth the lack of ME↔USIM authentication, where a USIM application is not able to securely detect it being swapped to another device (where it is assumed that an adversary is able to spoof the IMEI) since there is no authentication mechanism that securely ties any of the available device identifiers to any unique device.

Some examples of how the lack of authentication between ME and UICC could be harmful include:
If there is an autonomously operating IoT device, e.g. a temperature sensor, for example deployed in the forest. An attacker can take the SIM card from the IoT device and use it in their own device to make phone calls, possibly premium priced ones, use data services, etc. The attacker will not have to pay for the services used as the bill goes to the subscription/subscriber, i.e. the SIM card owner. It might take multiple days before the situation is noticed as it might require service personnel to visit the location of the IoT device to notice the issue, and dispatching a person to the site might not be seen as a high priority, thereby giving the attacker more time to use the service and increase the bill. The conventional approach of locking the SIM card to the phone IMEI is ineffective, as it is assumed that the adversary is able to clone the IMEI.
If the owner of the SIM is utilising Authentication and Key Management for Applications (AKMA) or Generic Bootstrapping Architecture (GBA)-based authentication to web services, an attacker could swap out the SIM card to their own device to access such services in the name of the victim and then swap it back without the victim noticing it. This of course requires that the attacker has access to the phone. However, without access to victim's biometrics (which is one of the default phone access authentication mechanisms today) the attacker could not unlock the victim's phone, while guessing a SIM pin of 1234 or 0000 might yield good results.
Again, IMEI locking is ineffective to this approach. A SIM PIN does offer some protection, but only for users who actively use it. It is considered that more and more users rely on biometrics and either disable PIN checking or use the default value.

US 2021/0314365 referenced above describes solutions where transmission characteristics are used to identify components/devices. While they show the feasibility of utilising such properties to identify changes, they are not directly applicable to a UICC-ME scenario.

None of the boot solutions described above are aimed at attesting hardware. While US 2021/0314365 describes a solution for attesting hardware, it is built on a description of the hardware, not the communication channel.

Certain aspects of this disclosure and their embodiments may provide solutions to these or other challenges. In particular, the physical UICC chip and the USIM application running on it can perform measurements of the ME, including both low-level parameters such as voltage and communication parameters, signal levels and duty cycle lengths; and higher-level measurements such as the order of accesses on the directories and files on the UICC master directory and/or the USIM application directory, an order of USIM commands and their parameters, and their timing information. These measurements can be input to a monitoring component that will first use these measurements to fingerprint the ME, and later, to detect if the fingerprint has changed from the established baseline, allowing the USIM application to react to the ME change, e.g. by ceasing its operation or signalling the Home Public Land Mobile Network (HPLMN) about the suspicious behaviour. That is, the monitoring component can determine a fingerprint for the ME from these measurements, and subsequent measurements can be compared to this fingerprint to determine if the ME has changed.

The above aspects provide fingerprinting and ME swap detection from within the UICC/USIM that do not require changes to the UICC/USIM↔ME protocol, allowing deployment of this solution without requiring changes to MEs. This solution would detect both the swapping of the ME (i.e. putting the UICC/USIM into a different ME) as well as hardware (HW) modifications to the ME, which typically could indicate attacks on the ME.

The aspects and/or embodiments described herein may provide one or more of the following technical advantage(s). In particular, the proposed solution does not require any changes to the ME or its interface to the UICC/USIM. It does not rely on ME IMEI, which can be spoofed. The solution is invisible to the ME, i.e. an adversarial party will not be able to identify whether a SIM supports fingerprinting from passive observations alone. Locking SIMs to a known ME makes it harder to take a SIM out of the device and set it up in an adversarial environment to leverage further attacks (e.g. voltage and clock glitching, etc.). The solution can potentially be used to detect adversarial changes to a device, e.g. attaching or soldering measurement probes (changes to impedance) and other hardware tampering. The solution can be deployed incrementally by the operator, i.e. one SIM at a time, and selectively, i.e. only for customers demanding or requiring higher security.

According to a first specific aspect of the techniques described herein, there is provided a method of operating a universal integrated circuit card, UICC, in a host mobile equipment, ME, the method comprising: measuring one or more characteristics of the host ME; determining if the characteristic measurements for the host ME are consistent with a first ME fingerprint corresponding to a first ME; and performing a first action if the characteristic measurements for the host ME are inconsistent with the first ME fingerprint.

According to a second aspect, there is provided a method of operating a universal integrated circuit card, UICC, in a first mobile equipment, ME, the method comprising: measuring one or more characteristics of the first ME; and determining a first ME fingerprint for the first ME from the characteristic measurements.

According to a third aspect, there is provided a method of operating one or more network nodes in a network, the method comprising: receiving a first message from a host mobile equipment, ME, that is registering and/or authenticating with, or is registered and/or authenticated with, the network; processing the first message to extract an indication of whether a universal integrated circuit card, UICC, in the host ME considers that characteristic measurements for the host ME are consistent with a first ME fingerprint corresponding to a first ME; and performing an action based on the extracted indication.

According to a fourth aspect, there is provided a computer program product comprising a computer readable medium having computer readable code embodied therein, the computer readable code being configured such that, on execution by a suitable computer or processor, the computer or processor is caused to perform the method according to the first aspect, the second aspect, the third aspect, or any embodiments thereof.

According to a fifth aspect, there is provided a universal integrated circuit card, UICC, for use in a host mobile equipment, ME, the UICC configured to: measure one or more characteristics of the host ME; determine if the characteristic measurements for the host ME are consistent with a first ME fingerprint corresponding to a first ME; and perform a first action if the characteristic measurements for the host ME are inconsistent with the first ME fingerprint.

According to a sixth aspect, there is provided a universal integrated circuit card, UICC, for use in a first mobile equipment, ME, the UICC configured to: measure one or more characteristics of the first ME; and determine a first ME fingerprint for the first ME from the characteristic measurements.

According to a seventh aspect, there is provided one or more network nodes for use in a network, the one or more network nodes configured to: receive a first message from a host mobile equipment, ME, that is registering and/or authenticating with, or is registered and/or authenticated with, the network; process the first message to extract an indication of whether a universal integrated circuit card, UICC, in the host ME considers that characteristic measurements for the host ME are consistent with a first ME fingerprint corresponding to a first ME; and perform an action based on the extracted indication.

According to an eighth aspect, there is provided a universal integrated circuit card, UICC, for use in a mobile equipment, ME, the UICC comprising: a control unit configured to control operation of the UICC; interface circuitry coupled to the control unit, wherein the interface circuitry is configured to connect to corresponding interface circuitry in the ME to enable electrical signals to be exchanged with the ME; and one or more probe components coupled to the interface circuitry and configured to measure characteristics of the electrical signals received from the ME via the interface circuitry.

According to a ninth aspect, there is provided a universal integrated circuit card, UICC, for use in a host mobile equipment, ME, wherein the UICC comprises a processor and a memory, said memory containing instructions executable by said processor whereby said UICC is operative to: measure one or more characteristics of the host ME; determine if the characteristic measurements for the host ME are consistent with a first ME fingerprint corresponding to a first ME; and perform a first action if the characteristic measurements for the host ME are inconsistent with the first ME fingerprint.

According to a tenth aspect, there is provided a universal integrated circuit card, UICC, for use in a first mobile equipment, ME, wherein the UICC comprises a processor and a memory, said memory containing instructions executable by said processor whereby said UICC is operative to: measure one or more characteristics of the first ME; and determine a first ME fingerprint for the first ME from the characteristic measurements.

According to an eleventh aspect, there is provided one or more network nodes for use in a network, wherein the one or more network nodes comprise a processor and a memory, said memory containing instructions executable by said processor whereby said one or more network nodes are operative to: receive a first message from a host mobile equipment, ME, that is registering and/or authenticating with, or is registered and/or authenticated with, the network; process the first message to extract an indication of whether a universal integrated circuit card, UICC, in the host ME considers that characteristic measurements for the host ME are consistent with a first ME fingerprint corresponding to a first ME; and perform an action based on the extracted indication.

According to a twelfth aspect, there is provided a universal integrated circuit card, UICC, for use in a mobile equipment, ME, the UICC comprising: a control unit operative to control operation of the UICC; interface circuitry coupled to the control unit, wherein the interface circuitry is operative to connect to corresponding interface circuitry in the ME to enable electrical signals to be exchanged with the ME; and one or more probe components coupled to the interface circuitry and operative to measure characteristics of the electrical signals received from the ME via the interface circuitry.

### BRIEF DESCRIPTION OF THE DRAWINGS

Some of the embodiments contemplated herein will now be described more fully with reference to the accompanying drawings, in which:

FIG. 1 is a simplified illustration of a conventional mobile equipment and SIM;

FIG. 2 illustrates different protocol layers in a terminal and UICC;

FIG. 3 illustrates a USIM application communicating with a terminal over a non-UICC interface;

FIG. 4 is a simplified illustration of a conventional mobile equipment and a SIM according to various embodiments;

FIG. 5 is a state transition model representing the operations of a monitor component in a UICC;

FIG. 6 is a signalling diagram illustrating communication establishment between a UICC and ME and USIM startup;

FIG. 7 is an example of a single character sent over an input/output line;

FIG. 8 is a signalling diagram showing the use of the fingerprint technique to allow or prevent network authentication according to some embodiments;

FIG. 9 is a signalling diagram showing the use of a SUCI to communicate a mismatch output of the fingerprint technique according to some embodiments;

FIG. 10 is a flow chart illustrating a method of operating a UICC in accordance with some embodiments;

FIG. 11 is a flow chart illustrating another method of operating a UICC in accordance with some embodiments;

FIG. 12 is a flow chart illustrating a method of operating one or more network nodes in accordance with some embodiments; and

FIG. 13 shows a network node in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As described above, the mobile equipment (ME) and the subscriber identity module (SIM) in the UE are distinguished from each other. A SIM is an example of a universal integrated circuit card (UICC) and may be physically implemented as a UICC (e.g. in the form of a conventional SIM card), in the form of an embedded UICC (eUICC), or in the form of an integrated UICC ((iUICC), e.g. where the UICC is a core integrated into a system on chip (SoC).

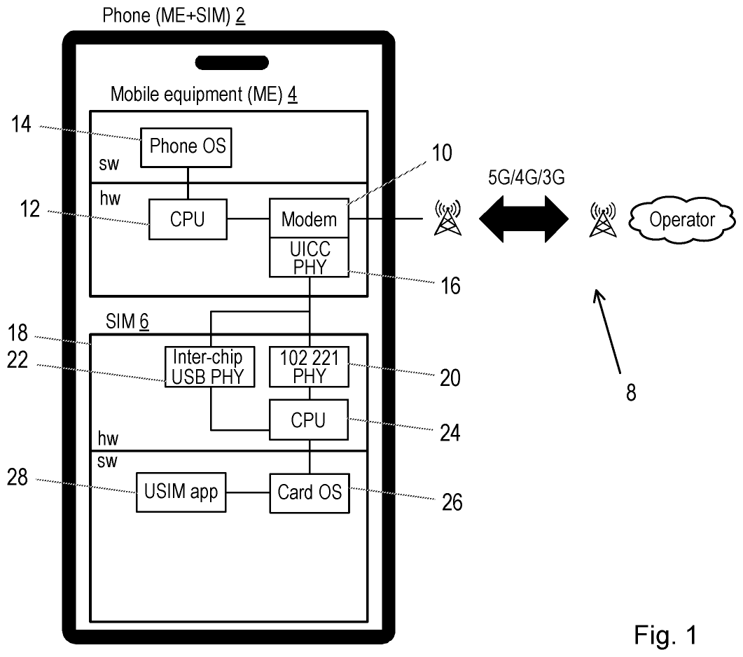

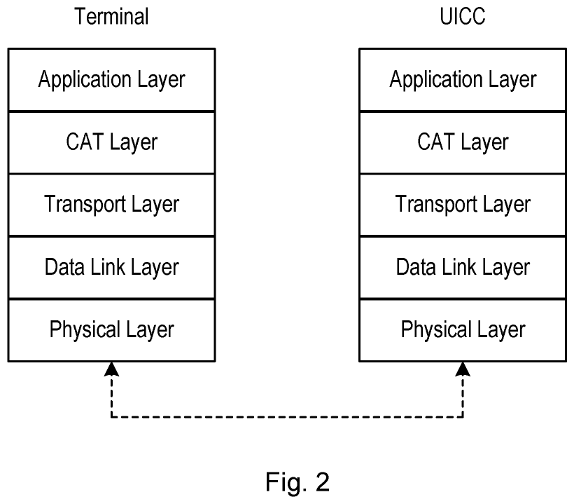

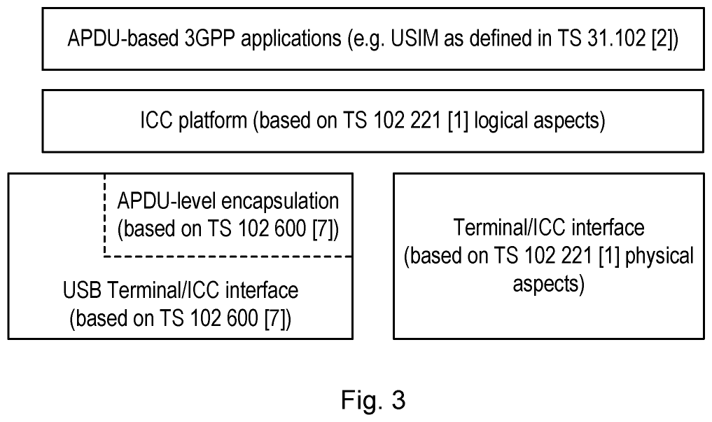

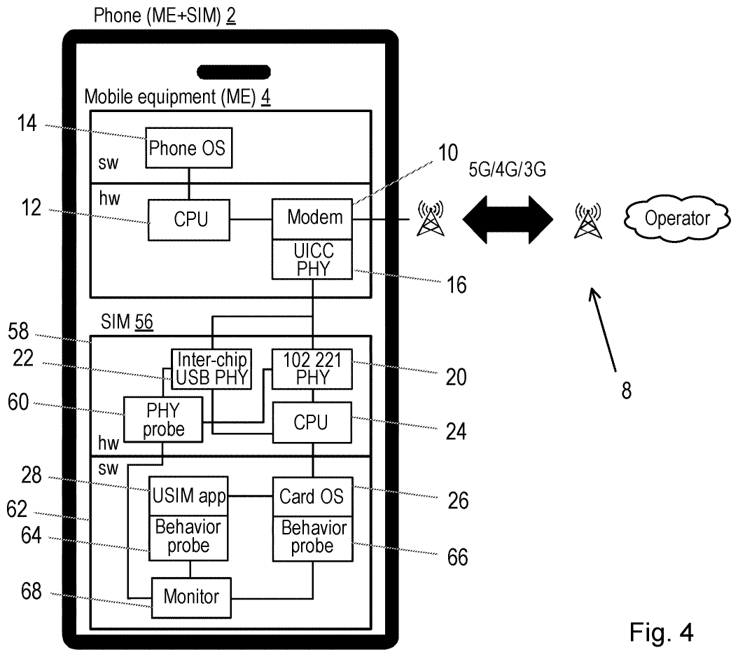

FIG. 4 illustrates a conventional ME and an exemplary UICC (in the form of a SIM) that can be used to implement the techniques described herein. FIG. 4 is similar to FIG. 1, and components and features that are common to the ME 4 and SIM are given the same reference numerals. Thus, the SIM 56 comprises hardware 58 which can include a conventional ETSI TS 102 221-compliant signalling interface 20 (102 221 PHY) and optionally a conventional ETSI TS 102 600-compliant USB interface 22 (Inter-Chip USB PHY) and a CPU 24.

The CPU 24 on the SIM 56 runs a custom operating system provided by the card manufacturer which is referred to as Card OS 26. The operating system 26 can host multiple applications running either sequentially or concurrently.

To enable the SIM 56 to ‘fingerprint’ the ME 4, the SIM 56 comprises one or more probes that can be used to measure characteristics of the ME 4. In some embodiments, the SIM hardware 58 can comprise a physical layer probe component 60 that can measure characteristics of any electrical signals received from the ME 4. In some embodiments, the SIM software 62 comprises a first behaviour probe 64 that can be used to measure or monitor characteristics relating to the activity or operations of the USIM app 28. In some embodiments, the SIM software 62 comprises a second behaviour probe 66 that can be used to measure or monitor characteristics relating to the activity or operations of the card OS 26. The SIM software 62 can also comprise a monitor component 68 that can collect or receive the measurements of the characteristics from the one or more probes 60, 64, 66, and implement the fingerprint techniques described herein (e.g. including the techniques of deriving or determining the fingerprint for the ME 4 and/or the techniques of comparing characteristics for the ME 4 to a fingerprint of a ME.

It will be appreciated that while FIG. 4 shows the SIM 56 as comprising multiple distinct probes 60, 64, 66, the functions of two or more of the probes may be combined into a single entity or component.

The additional capabilities provided in the SIM 56 relate generally to two different steps: (i) the monitor 68 performing fingerprinting and stored fingerprint matching, and the SIM (UICC) 56 reacting to the (positive or negative) fingerprint matching result.

These steps are described more in detail below. While the steps and much of this disclosure is described with respect to a physical discrete removable UICC in the form of a SIM card, it will be appreciated that the techniques are readily applicable to other forms of UICC, such as a eUICC and iUICC.

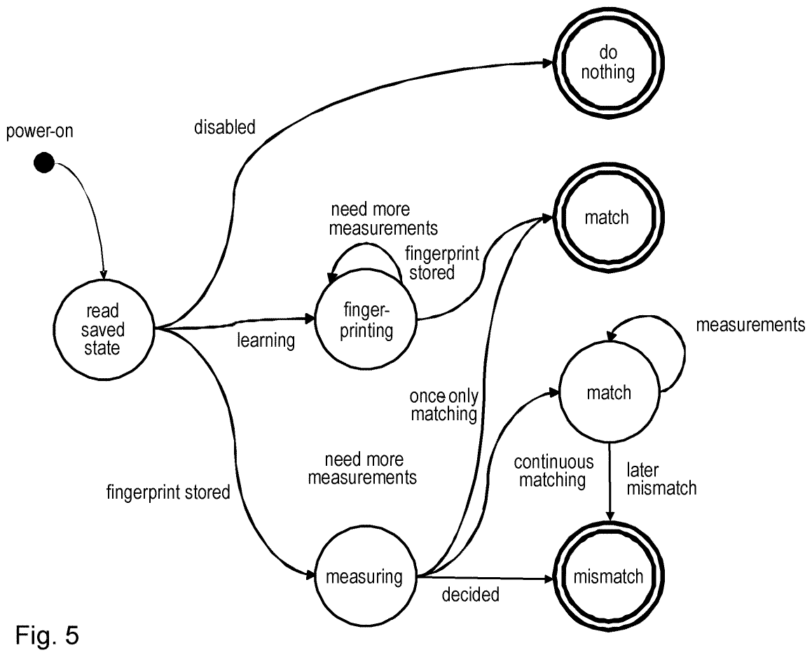

The operations of the monitor component 68 can be expressed in terms of a state transition model. An exemplary state transition model for the monitor component 68, i.e. the part of the UICC that performs the fingerprinting and stored fingerprint matching, is shown in FIG. 5. It will be appreciated that the monitor component 68 can follow alternative state transition models (e.g. that follow a different sequence of events) to that shown in FIG. 5. The monitor component 68 can persistently store information on whether it is disabled (i.e. the fingerprinting generation/detection algorithm is deactivated), learning a fingerprint (also referred to as ‘enrolment’), or has already learned a fingerprint.

If the operations of the monitor component 68 are disabled, it will not perform any operations. Otherwise, the monitor component 68 will start collecting measurements of the ME that is hosting the UICC (i.e. the ME in which the UICC is present). The measurements can be collected from any one or more of the UICC PHY 20/22, the card OS 26, and the USIM application 28. The monitor component 68 may need to collect measurements for a period of time until it determines that it is has sufficient data available to either store a learned fingerprint, or compare the measured fingerprint to a stored fingerprint (or compare measurements to a stored fingerprint) to determine if the measured fingerprint/measurements is consistent with the stored fingerprint. In the latter case the result may be either a match (i.e. consistent) or a mismatch (i.e. inconsistent) against the stored fingerprint.

When a new SIM 56 is provisioned, it will either initially, or after an explicit enabling action, enter an enrolment phase. During this phase, the monitor component 68 receives measurements from one or more probes 60, 64, 66 in the SIM 56 and uses these to create a fingerprint of the ME 4. Such a fingerprint may be or include a mean and/or an expected variance, explicit thresholds for the measurement(s) or a machine learning (ML) model trained on the measurement values. It may also be a combination of two or more of these.

Additionally, or alternatively, the monitor component 68 may receive a configuration from the SIM vendor, the home network operator (at least it might be provisioned by it), or the end-user of the SIM 56. The configuration may specify what is considered to be a match/mismatch, e.g., time limits for how long a threshold must be exceeded, how many measurements which need to be exceeding the threshold at one point, before action is taken. The configuration may further specify how often the monitor should evaluate the measurement values.

The monitor component 68 may also be reset, in which case it will either be disabled, or re-enter the enrolment phase. This can be controlled by the USIM application 28.

In the monitoring phase, the monitor component 68 may use the fingerprint and the configuration. If the measurements received from the probe(s) 60, 64, 66 fall outside of the fingerprint and the configuration deems the measurement abnormality to be severe enough to be classified as a mismatch (e.g. an attack on the security of the UE), the monitor component 68 can signal this to the USIM application 28 which can then take action, if appropriate. Alternatively, or additionally, the monitor component 68 may supply the detected measurement abnormality or an indication of the existence of the abnormality, to the home network (e.g. home public land mobile network (HPLMN)) for the SIM 56. This is described further below.

In some embodiments, the fingerprint matching can be one-shot, i.e. once a decision has been made, the only way to alter the decision is to either reset the learned fingerprint or restart the ME 4 (which restarts the fingerprinting and matching process). Alternatively, the monitor component 68 functionality could continue to accumulate more measurements and re-evaluate the fingerprint matching continuously. This could, for example, detect a “hot swap” of the SIM 56, where the SIM 56 is first connected to a real ME, and then, without interrupting the power or clock signals, switched to be controlled by another ME.

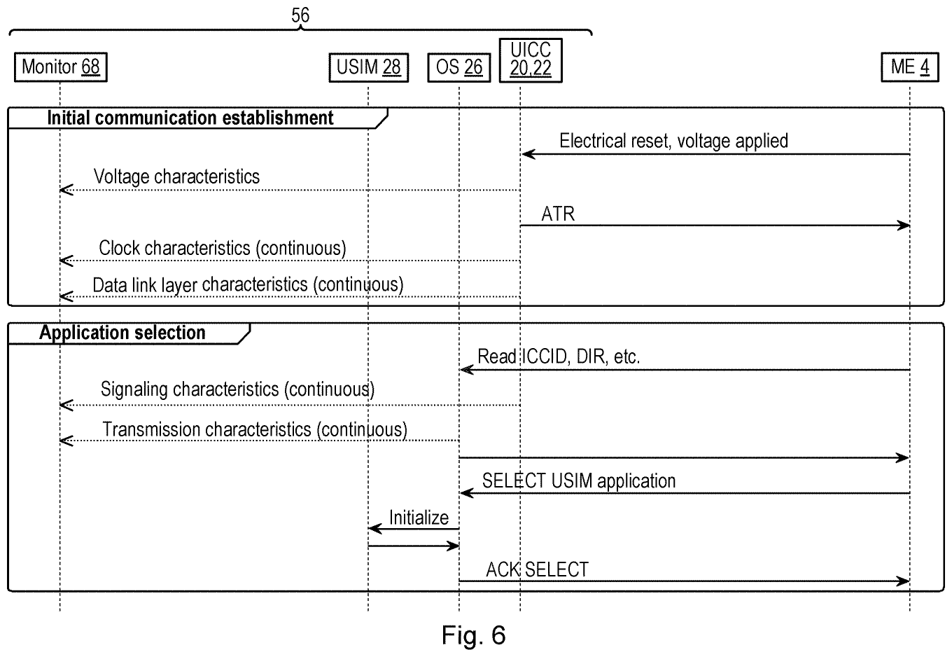

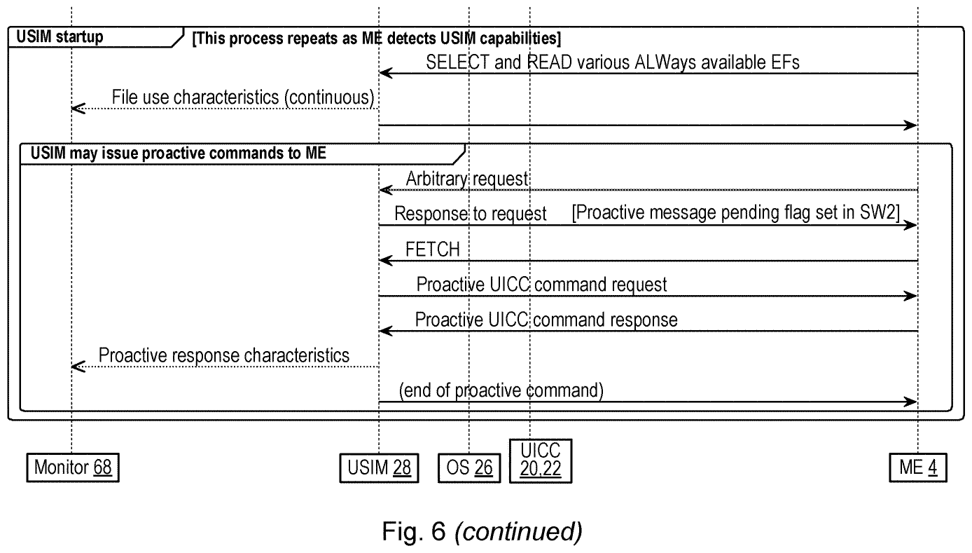

The sequence diagram in FIG. 6 provides an abstracted (i.e. omitting some technical details) view of how a SIM 56 is initialised (i.e. early UICC initialisation and USIM setup). The signals sent to the monitor 68 are from the probes 60, 64, 66. Some details are abstracted, e.g. the proactive UICC issuance is a bit more complicated on the protocol level.

The first step is for the ME 4 to provide power and clock signals to the SIM card 56, which will perform a low-level initialisation, and respond with an ATR (Answer To Reset) data. The ME 4 uses the ATR response to potentially change the supply voltage and other logical characteristics (powering off the SIM 56 and restarting the power-up with new electrical parameters). Once the low-level electrical parameters have been agreed, the ME 4 will retrieve various elementary files (EFs) from the UICC filesystem allowing it to identify the device (e.g. the EF Integrated Circuit Card Identifier (EF_{ICCID})) and the applications it supports (EF_{DIR}). Since a single UICC 56 may support multiple different applications, the ME 4 can use this process to determine whether the SIM card 56 provides some version of the USIM application 28 it can communicate with. Once the USIM application 28 has been identified, the ME 4 will issue a SELECT command to activate the USIM application 28.

Furthermore, once the USIM application 28 is activated, the ME 4 will read various files the application 28 provides that can be read prior to authentication (known as “always allowed” files). These help the ME 4 determine the exact capabilities of the USIM application 28, the types of networks it supports, the preferred networks to join, interface language, etc. The USIM application 28 may also issue proactive UICC commands to retrieve information from the ME 4 as well. At the protocol level, the UICC does not “issue” UICC commands—instead the ME 4 has to send a request to the UICC 56 to retrieve a proactive command. The UICC 56 may, at any point, indicate that it wants to issue a proactive command by indicating this in the SW2 status word of any reply it sends (for any request from the ME 4). However, from the application point of view, it will simply issue a proactive command, and the transport layer will handle setting SW2 and waiting for the ME FETCH command.

During the above processes, the UICC PHY probe 60, the OS probe 66, and the USIM application probe 64 will supply measurements of the relevant characteristics to the monitor component 68. The types of these measurements vary by the probe type. For example, the PHY probe 60 supplies low-level characteristics such as voltage information, signal transition edge accuracy, and slew rates, among others. The Card OS 26 can provide information that occurs outside the control of the USIM application 28 (such as the order of file retrieval and timing between them), and USIM information that is open in the USIM protocol commands, as well as any extra information it can retrieve with proactive UICC commands. While data may be a fingerprint characteristic, the low-level physical characteristics (due to impedance variations in interface components) and behavioural differences (between the CPU 12 in the ME 4 and phone OS 14 implementations) are more important, since they are more difficult to replicate than pure data.

There are various characteristics that can be measured by the UICC PHY probe 60, the Card OS probe 66, and the USIM application probe 64. Some of these characteristics may vary based on physical characteristics of the individual discrete components (chips, capacitors, resistors, inductors, transmission lines and contacts), varying due to differences in software across devices and releases, to high-level responses such as the IMEI value. The characteristics vary in the effort required for perfect duplication by an adversary from extremely hard (electrical) to potentially quite trivial (OS-level data).

Electrical characteristics—ETSI TS 102 221 v17.0.0 defines the UICC electrical specifications, and allows the supply voltage (VCC) to vary within the following bounds in four discrete levels:
Class A: 4.5 V to 5.5 V
Class B: 2.7 V to 3.3 V
Class C: 1.62 V to 1.98 V
Class D: 1.1 to 1.3 V

The eventual choice of the supply voltage can vary in multiple ways. For example:

1. The SIM 56 may indicate it supports lower voltage levels (in ATR response) than the initial cold reset voltage, allowing the ME 4 to step down the operating voltage—MEs 4 may differ in their support, so for example, if the SIM 56 indicates it supports all of the voltage classes, one ME 4 may support all and start with class A then change to D, and another might support only A and C. MEs 4 can be assumed to choose the lowest possible voltage level the SIM 56 supports to reduce power consumption.

2. The mean voltage for a class may differ from ME to ME. The voltage regulator (converter) may have physical manufacturing differences that fit within the manufacturing tolerances. That is, one ME 4 may supply level 1 as 5.00 V and another as 4.98 V even if they have the same make and model of the voltage regulator.

3. The ripple, i.e. deviations from the mean voltage level, can vary from ME to ME. Two devices with the same mean VCC=5.00 V may still differ in their measurable ripple (noise) as +0.01 V for one device and +0.05 V for another.

4. Behaviour with regards to the mean VCC and ripple can also vary based on current (drawn by the SIM 56) and temperature. The VCC may be 5.00 V during initial startup (low current draw), but during later stage when the USIM 56 is doing cryptographic computations (high current) it could drop to 4.95 V.

That is, even for a simple supply voltage VCC can already produce measurable differences that vary (most definitely) between different ME models, but potentially also between two MEs of the same make.

It should be noted that even the voltage switching after ATR may be measurable: for example MEs may take different times to switch from one voltage to another. This would require the SIM 56 to be able to measure the time difference between two VCC high levels by relying only on (small) amount of capacitively stored energy and a low-power independent timer.

All of these electrical characteristics vary based on the ME vendor's choice of voltage regulation, bypass and filtering capacitors, and also on the individual variability of characteristics of the actual specimens used in the manufacture.

Clock characteristics—The ME 4 supplies an external clock signal to the SIM 56, to be used in the UICC protocol. The electrical characteristics of the clock are defined in Table 5.3 of ETSI TS 102 221 v17.0.0, which is shown below:

TABLE 5.3
of ETSI TS 102 221 v17.0.0

| Symbol | Conditions | Minimum | Maximum | Unit |
|---|---|---|---|---|
| V_{OH} | I_{OHmax} = +20 μA | 0.7 × Vcc | Vcc (see note) | V |
| V_{OL} | I_{OLmax} = −200 μA | 0 (see note) | 0.5 | V |
| t_{R} t_{F} | Cₒᵤₜ = Cᵢₙ = 30 pF | | 9% of period with a | |
| | | | maximum of 0.5 μs | |

(NOTE):
To allow for overshoot the voltage on CLK shall remain between −0.3 V and Vcc + 0.3 V during dynamic operation.

Table 5.3 shows that the high voltage can vary significantly, for example for a Class C device VOH=[1.13, 1.98] V. The clock frequency f=[1, 5] MHz and duty cycle between 40% and 60% have a wide possible variance that can be measured. Therefore, there are several measurable characteristics of the clock signal: frequency, high and low voltage levels, and duty cycle. In addition, since a clock signal is a periodically transitioning signal, it has also other measurable properties. For example, while the frequency itself may be stable, there may be clock signal dispersion i.e., deviation from the expected clock edge location. The clock driver is also limited by the slew rate of the transition, affecting the rise and fall time of the signal (which is also potentially impacted by various filtering capacitors). Furthermore, no digital signal is free from overshoot and undershoot, and the settling time of the signal due to ringing can also vary from one device to another.

Logical characteristics—The actual data contents of the ME↔SIM communication are transferred over a physical contact as well, where the input/output (I/O) signal has specific electrical requirements. Table 5.4 shown below shows the UICC I/O signal electrical tolerances for Class A operating mode:

TABLE 5.4
in of ETSI TS 102 221 v17.0.0

| Symbol | Conditions | Minimum | Maximum | Unit |
|---|---|---|---|---|
| V_{IH} | I_{IHmax} = ±20 μA | 0.7 × Vcc | Vcc + 0.3 | V |
| | (see note 2) | | | |
| V_{IL} | I_{ILmax} = +1 mA | −0.3 | 0.15 × Vcc | V |
| V_{OH} | I_{OHmax} = +20 μA | 3.8 | Vcc | V |
| (see note 1) | | | (see note 3) | |
| V_{OL} | I_{OLmax} = −1 mA | 0 (see note 3) | 0.4 | V |
| t_{R} t_{F} | Cₒᵤₜ = Cᵢₙ = 30 pF | | 1 | μs |
| | | | 100 (see | ns |
| | | | note 4) | |

(NOTE 1):
It is assumed that a pull-up resistor is used in the interface device (recommended value: 20 kΩ).
(NOTE 2):
During static conditions (idle state) only the positive value can apply. Under dynamic operating conditions (transmission) short-term voltage spikes on the I/O line may cause a current reversal.
(NOTE 3):
To allow for overshoot the voltage on I/O shall remain between −0.3 V and Vcc + 0.3 V during dynamic operation.
(NOTE 4):
This value applies when the low impedance buffer is selected.

Additionally, since the signal line is changing between low and high values, it may contain measurable device-to-device differences in the signal rise and fall rates, over- and under-shoot voltages, and settling time, as was above with the clock signal.

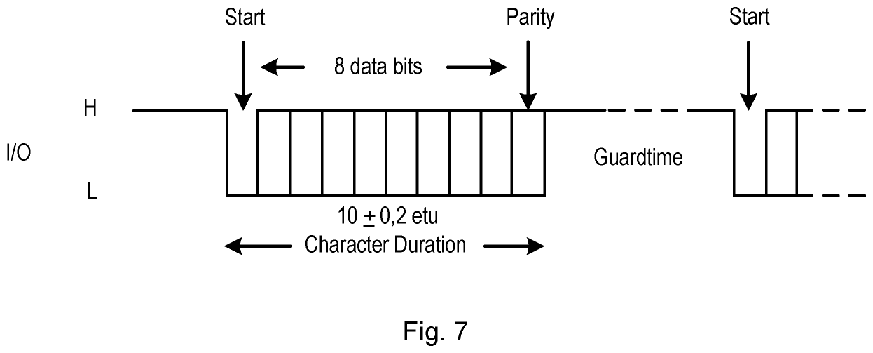

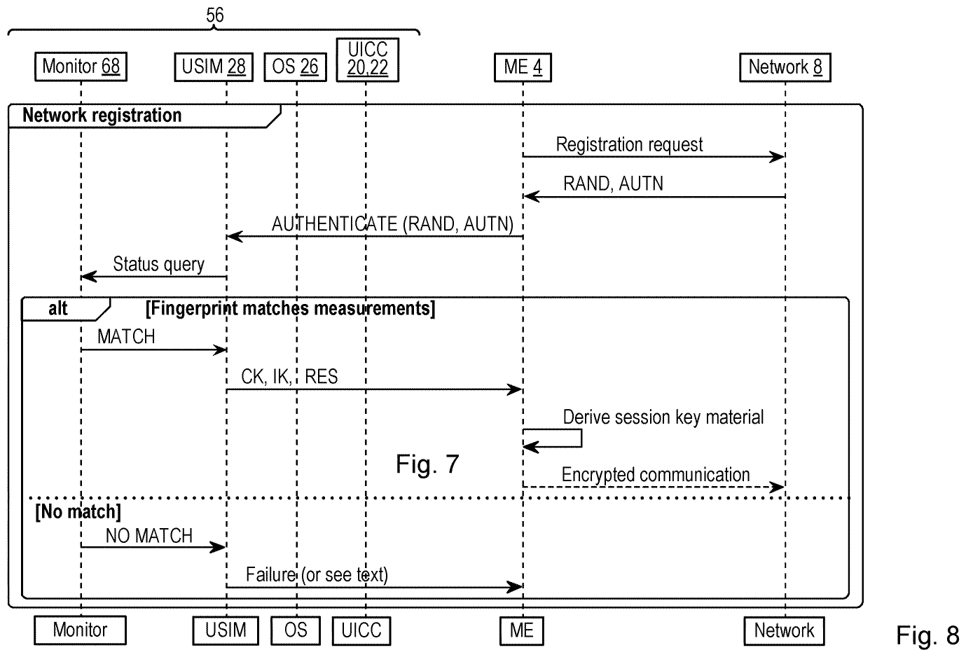

Data link protocol characteristics—The data link protocol defines how individual characters are encoded and transmitted over the I/O line. An example of a single character sent over the I/O line is shown in FIG. 7, which corresponds to FIG. 7.2 in ETSI TS 102 221 v17.0.0.

The logical signal electrical characteristics are described above, and the data link protocol allows one to also measure the accuracy of the character duration (for example if one device uses 10.05 time units and another 9.90 for a single character, both are within the nominal tolerance) as well as the guard time. These may also have current and temperature coefficients, as well as inherent variance e.g. (some devices may have “noisier” guard time with higher variance from the mean).

The transmission layer also has concepts of blocks, chaining, error detection, resynchronisation, etc. which all can be potential sources of differences in behaviour across devices.

Transport protocol characteristics—The transport layer relies on the data link layer to transmit bytes and blocks over the I/O line. It focuses on Application Protocol Data Units (APDUs) and their transport. This is described in section 7.3 of ETSI TS 102 221 v17.0.0, and allows some variation and decision in how an APDU is encoded and transported over the data link protocol. These choices may potentially reflect differences in a low-level implementation of the transport protocol drivers.

Application selection protocol characteristics—Once the ME↔SIM handshake and transport protocol have been established, the ME 4 will typically read several files from the master file (MF) record that the SIM 56 defaults to after a reset. The 3GPP mandates EF_{ICCID}, EF_{DIR}, DI, EF_{ARR} and EF_{UMPC} files to be supplied, with the directory DFCD as optional, as described in 3GPP 31.101 v17.0.0. The following characteristics can vary in how the ME accesses these files: which files are accessed (the ME may not read all files), the order in which they are accessed, and the time difference between these accesses.

At some point, potentially after reading EF_{DIR} and detecting the USIM application 28 as present on the SIM 56, the ME 4 will issue a SELECT AID command instructing the card to start the USIM application 28. Whether the Card OS 26 really starts the USIM application 28 only at this point, or whether the USIM application 28 is already running and will receive a “you are selected” signal from the Card OS 26 is an implementation detail in the card 56 itself, and is not visible to the ME 4.

It should be noted that at this level most of the differences are due to firmware and operating system differences, and not due to inherent electrical and manufacturing differences between two devices of identical make. Therefore, this, USIM 56, and proactive UICC commands are more useful in distinguishing swaps between two devices that are either of different make and model (different manufacturers), or in some cases, between two devices of the same type that have different firmware and operating system versions. At the extreme end, it might be possible to detect a rooted phone if the rooting has impact on the phone OS load or kernel driver parameters.

USIM application protocol characteristics—The USIM application protocol (as set out in 3GPP TS 31.102 v17.4.0) is complex. Once the USIM application 28 is selected, there may be significant variability from one device to another based on any of: which commands the ME 4 issues (such as file reads; 3GPP TS 31.102 v17.4.0 section 4.2 defines 51 EFs as part of the USIM application directory), in what order, what parameters it uses (if applicable), and what the time intervals are between the various commands.

Proactive UICC information characteristics—The USIM 56 may also issue commands to the ME 4 using proactive UICC. This interface is called the USIM application toolkit (USAT) in 3GPP TS 31.111 V17.2.0 (2021 December) “Universal Subscriber Identity Module (USIM) Application Toolkit (USAT) (Release 17)”. This USAT defines 44 commands that can be issued to the ME. Many of these are not, however, used regularly by a SIM, or have side effects (such as having user-visible effects) meaning they cannot be used invisibly by the USIM.

Some proactive UICC commands include POLL INTERVAL, TIMER MANAGEMENT, RUN AT COMMAND, SERVICE SEARCH, geographical location request, and PROVIDE LOCAL INFORMATION (this list is not exhaustive). While it can be assumed that an attacker (i.e. a party that is trying to get the SIM 56 to reveal sensitive information) is able to fake any returned data (such as IMEI via PROVIDE LOCAL INFORMATION), a careless attacker might return the values without taking into account of the processing time required on the real (original) ME, allowing the time taken by the ME to process the proactive command to be used as a measurement. Consider, for example, a ME where the IMEI is derived from hardware identifier for each request, whereas a careless attacker may hardcode the result into the protocol emulator, returning the result faster than in the original device.

Inter-chip USB protocol characteristics—ETSI TS 102 600 V10.1.0 (2020 September) Smart Cards; UICC-Terminal interface; Characteristics of the USB interface (Release 10) defines a USB protocol over the physical SIM chip contacts, which can be seen as a high-performance connection to the UICC capabilities. The USB protocol itself is a host-driven protocol, just like the core UICC protocol (described in ETSI TS 102 221 v17.0.0) where the host sends a request to the device which then replies back. However, unlike the historical UICC protocol (which supersedes USB), USB is much more flexible. In theory, the SIM 56 can represent multiple devices over the USB protocol, including keyboards and network interface cards. In practice, the host ME 4 is likely to severely restrict the USB device capabilities in the SIM device. However, this does not prevent the USB protocol, including its electrical and signalling parameters, from providing a useful source of measurements for fingerprinting a ME 4. The timing across USB commands, the order in which they are issued, etc., can also be measured. In some embodiments, the UICC can impersonate various types of USB devices and detect differences in ME behavior to those USB devices, where some may choose to activate some types of USB device types, while others may ignore them.

As noted above, the monitor component 68 can perform fingerprint generation and, subsequently, fingerprint matching to determine if the UICC 56 is present in the same ME 4, or if the ME 4 has been tampered with since the generation of the fingerprint, or if the software/firmware of the ME 4 has been updated or changed since the fingerprint was generated.

As techniques for generating fingerprints from a set of measurements are generally known in the art, the present disclosure does not provide significant details about the generation, storage or matching of fingerprints. For example, some techniques for generating fingerprints from a set of measurements derived from different types of measurement sources, including physical and on a higher protocol are described in: “Identifying unique devices through wireless fingerprinting” by Loh Chin Choong Desmond et al., WiSec '08: Proceedings of the first ACM conference on Wireless network security, March 2008, pages 46-55; “Network Protocol System Fingerprinting-A Formal Approach” by Guoqiang Shu and David Lee; “Passive os fingerprinting methods in the jungle of wireless networks” by Martin Lastovicka et al., NOMS 2018-2018 IEEE/IFIP Network Operations and Management Symposium, 2018, pp. 1-9; and “IoT Device Fingerprint using Deep Learning” by S. Aneja, N. Aneja and M. S. Islam, 2018 IEEE International Conference on Internet of Things and Intelligence System (IOTAIS), 2018, pp. 174-179. In general, there are various approaches that can be taken, of which two are briefly described. The first option is relatively simple and lightweight, and the second option is significantly more costly (in terms of processing resources) to implement. The first option makes use of statistical correlation techniques, while the second option makes use of artificial intelligence (AI) or machine learning (ML) models.

In the case of statistical correlation, fingerprinting would identify through statistical analysis those measurements of the characteristics that are both stable enough (variance is not too high) and are known to vary from one device (ME) to another. The stored fingerprint can consist of mean and/or variance information for the selected characteristics, and matching can compare the current measurements against the fingerprint, using either threshold matching, e.g. with N-out-of-M MATCH vs. NO MATCH choices, or using a more elaborate fuzzy matching algorithm, for example where error correcting algorithms are used which allow a pre-defined degree of errors in the measurements. The algorithms may further be configured to let different measurements have different error tolerance.

It is unlikely that a full AI/ML model would be trained in a SIM 56 due to the processing constraints inherent in such a component. However, a model can be partly trained offline (i.e. separate from the SIM 56) using a variety of measurements from a realistic selection of MEs. When the measurements of a particular ME are applied to this model by the SIM 56, the output weights for the model can be recorded as the fingerprint for the ME 4. Another method would be to use transfer learning to tune a previously trained generic model into a ternary classifier (e.g. MORE DATA NEEDED/MATCH/NO MATCH) tailored for the specific fingerprinted ME.

In some embodiments, the generation of the fingerprint and/or evaluation of a stored fingerprint can be enhanced using information stored in templates for particular models of ME. In particular, while the UICC 56 can measure and learn the typical behaviour and characteristics of the ME 4 from scratch, it can be useful for the UICC 56 to have a template available for a particular model of ME (or for MEs from a particular manufacturer) that indicates what characteristics should be measured and/or in what range those values should be. Alternatively, the template may be a ML model that is to be fine-tuned to a particular ME 4. During the fingerprinting/enrolment phase these values can be adjusted so that they are applicable to the ME 4 being evaluated. These templates could be based on manufacturer measurements and estimates, but could also be generated and updated based on active UICCs that are able to report generated fingerprints to the network 8.

The following section describes the detection and reaction to a fingerprint mismatch in the USIM application 28. In some embodiments, the monitor component 68 described above may only make a decision on the match (i.e. consistency) of current measurements against a stored ME fingerprint. The action(s) taken after a consistency decision (match or no match) is derived can be up to the USIM application 28 and any configured security policy. For the UICC 56, the goal is to prevent an undesirable alteration to the operating environment. This alteration can be, for example, the UICC having been moved to another ME, the addition of electrical probing or switching circuitry between the UICC and the ME, or physical alterations to the ME itself.

Regardless of the exact attack vector, what the UICC 56 is protecting from an adversary is its contents, with an emphasis on the authentication credentials the ME 4 needs to authenticate itself to the network 8. These credentials are used—but not revealed—during the network registration phase. Therefore, a natural decision point is the moment when the ME 4 requests the UICC 56 to perform network authentication. The UICC's actions are described below assuming that the network authentication step is where the monitor component's fingerprint match/no match decision is used, although in practice the taking and use of this decision can occur both earlier and/or later during ME-UICC interactions.

FIG. 8 shows the signalling involved in the use of the fingerprint technique to allow or prevent network authentication according to some embodiments. FIG. 8 shows the signalling between the components of the UICC 56, the ME 4 and the network 8. Thus, the ME 4 initiates authentication with the network 8 (the authentication is eventually handled by the home network's Authentication Server Function (AUSF), but for the purposes of FIG. 8 it is sufficient to simply note that the ME 4 accesses the network 8). The ME 4 receives RAND and AUTN parameters from the network 8 as part of the authentication request.

To get the session keys, the ME 4 will issue an AUTHENTICATE request to the USIM application 28 (as described in 3GPP TS 31.102 mentioned above), which will use a long-term key K (shared with the home mobile network operator (MNO)) to authenticate RAND and AUTN, and if successful, will derive and return the CK and IK key material to the ME 4 (as well as the authentication response RES). The ME 4 can then use CK and IK to derive session keys (KAUSF, KgNB etc.), and initiate encrypted communications with the network 8.

According to embodiments of the disclosed techniques, instead of immediately returning the CK and IK parameters, the USIM application 28 can query the monitor component 68 to check whether the ME 4 behaviour—as represented by characteristic measurements—is consistent with the stored fingerprint (MATCH) or not consistent (NO MATCH). If there is a match, the USIM application 28 proceeds to return CK and IK to the ME 4 as normal. If a NO MATCH condition is detected, it can instead return an error to the ME 4, or not respond to the ME 4 at all. This will prevent the ME 4 from completing registration with the network 8, as the ME 4 will be unable to calculate the correct key material.

It should be noted that the query may be, instead, a local flag within the USIM application 28 based on asynchronous notification from the monitor component 68 that is sent by the monitor component 68 once it reaches a decision. For simplicity, the synchronous polling method is shown in FIG. 8.

As noted, described here is one potential decision point for the techniques described herein, i.e. a point in the ME↔Network protocol where the UICC 56 can make an impactful decision. This and other decision points are described further below. In addition, one potential action to a NO MATCH condition has been described. Further/alternative actions are also described below, and include actions which affect the UICC 56 and ME 4 only, and additional actions with the HPLMN 8.

Decision points—A “decision point” as used herein is a moment in the ME↔UICC interactions/protocol where the UICC 56 can choose to deviate from the “normal” behaviour in a way that has a significant impact on the ME's or attacker's capabilities to leverage the UICC 56 for further actions.

AUTHENTICATE: The AUTHENTICATE decision point occurs, as described earlier, during the registration of the ME 4 to the network 8. As part of the registration reply, the network 8 provides the ME 8 with RAND and AUTN parameters. To derive the network session keying material, the ME 4 needs CK and IK parameters which require access to the long-term authentication key K, and which is accessible only to the USIM application 28.

Therefore, a successful network registration procedure requires co-operation from the UICC 56/USIM application 28. This allows the UICC 56 to deny access to the network 8 by the ME 4 if the monitor component detects a NO MATCH condition.

PIN: If the NO MATCH result can be reliably determined earlier than the authentication procedure, for example before a user's personal identification number (PIN) for the UICC is verified using the VERIFY PIN command by the ME 4, then the NO MATCH result can be used to prevent further use of the UICC 56. In this case, the UICC 56/USIM application 28 can reject any/all PIN codes input to the ME 4 to be used to unlock the UICC 56, even if the correct PIN is entered by a user of the ME 4.

If desired (and so configured), the UICC 56/USIM application 28 could enter a personal unblocking key (PUK) lockdown, which allows the stored fingerprint to be reset on a successful entry of a PUK code. This would be a useful model under the assumption that the attacker has no access to the PUK code. This could correspond to a “regular user” scenario where the PIN is not very secure (i.e. it could be set to a default value, e.g. 1234), but the ME 4 has biometrics or other strong authentication enabled. In this case, the attacker could transfer the UICC 56 to an unlocked ME 4 and attempt to use the known or easily guessable PIN. In this case, a NO MATCH condition occurring before or during PIN entry would allow the UICC 56/USIM application 28 to prevent further use of the UICC 56. In contrast, a regular user switching MEs would be assumed to have access to the PUK code. All they would need to do after swapping the UICC 56 to a new ME 4 would be to enter the PUK code, resetting the stored measurement data and allowing the UICC to learn the fingerprint of the new ME 4.

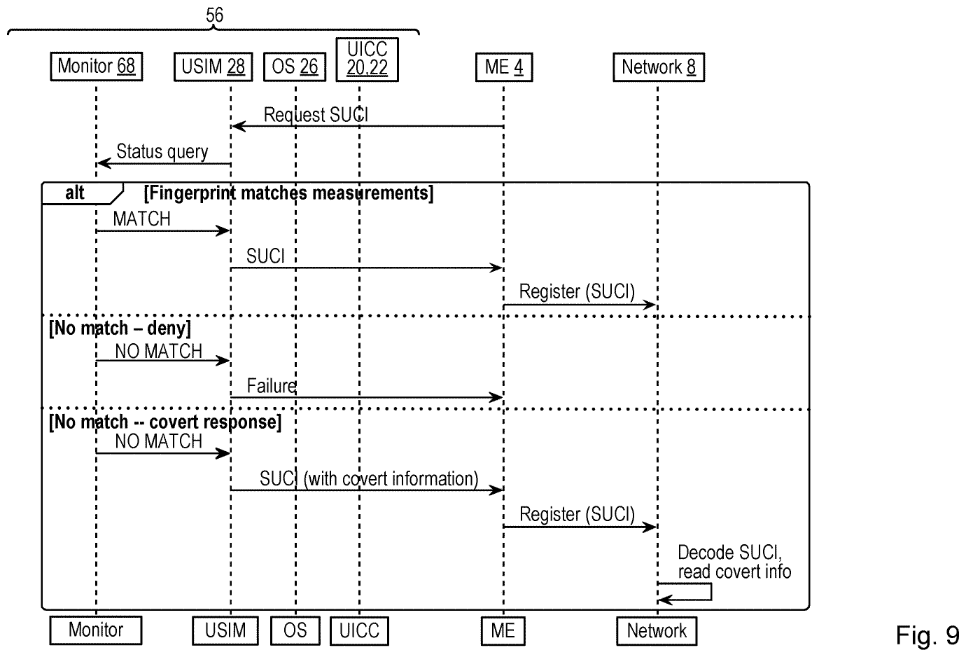

Subscription Concealed Identifier (SUCI): In the case of 5G registration, the ME 4 requires the use of a SUCI parameter to identify the subscription to the home MNO. 3GPP TS 31.102 V17.4.0 indicates that the subscriber's identity (Subscription Permanent Identifier (SUPI) may be kept confidential by the UICC 56 (services 124 and 125 in 3GPP TS 31.102 V17.4.0) and provided to the ME 4 only in a concealed (e.g. SUCI) format. This allows the UICC 56/USIM 28 on a NO MATCH to simply deny the SUCI from the ME 4. Alternatively, the UICC 56/USIM application 28 can use the SUCI's encrypted portion as a covert channel to signal information to the network 8 that cannot be interpreted or read by the ME 8. This covert channel can be used to communicate to the MNO 8 that it received a NO MATCH condition from the monitor component 68 (i.e. the UICC 56 is present in a ME 4 that is different to the one from which the stored fingerprint was derived). The SUCI embodiments are illustrated in FIG. 9, which shows the signalling between the components of the UICC 56, the ME 4 and the network 8. Both the first option of denying the SUCI from the ME 4 and the second option of using the SUCI as a covert channel are shown in FIG. 9.

Since the ME 4 cannot register itself to the network 8 without a SUCI, the SUCI request from the ME 8 to the UICC 56/USIM application 28 is also a possible decision point.

The use of the SUCI as a covert channel enables remote actions by the network 8, as the covert channel can be used to inform the network 8 about the mismatch of the measured characteristics of the ME hosting the UICC 56 to the stored fingerprint. In this case, the home network 8 can become an active participant in the response to the mismatch.

The discussion above assumes a simple deny action in response to the mismatch (inconsistency), where the UICC 56/USIM application 28 effectively stops cooperating with the ME 4 and prevents any further use of the UICC 56 until it is power cycled. This action, and some other local actions (i.e. actions that can be performed by the UICC/USIM itself) are described more in detail below.

Deny: The simplest action when a NO MATCH is detected is simply to stop cooperating with the ME 4. There are a few key decision points in the ME↔UICC interaction where the behaviour of the UICC has a significant impact:
1) PIN entry, prior to which PIN-protected files in the USIM application 28 are locked,
2) SUCI retrieval,
3) Initial AUTHENTICATE to generate network keying material, and
4) Re-AUTHENTICATE—This is similar to AUTHENTICATE, with the difference that the UICC 56 might notice discrepancies well in advance of the re-authentication taking place, i.e. between AUTHENTICATE and re-AUTHENTICATE, but it will be able to act on it only once the RE-AUTHENTICATE process is run.
5) Application layer authentication—subscription credentials can be used for application layer authentication, e.g. via GBA or AKMA. If primary authentication has not been performed and AKMA is needed, then the USIM access is needed in AKMA as well. GBA can be used at some point after (or before) initial authentication and requires access to the USIM, similar to re-authentication.

The earlier the UICC can react to a NO MATCH, the more effective the deny strategy is as it permits more options on how to react.

PIN lock—If the UICC 56 detects a NO MATCH at any point (including any of the decision points outlined above), it can record the fact in memory (e.g. in non-volatile random access memory (NVRAM)) and force a reset (REFRESH with UICC Reset, as described in ETSI TS 102 203 V15.3.0 (2019 July) Smart Cards; Card Application Toolkit (CAT) (Release 15). Subsequently, the UICC/USIM application will behave as a PIN locked UICC, requesting the user enter a PUK code to continue. If a successful PUK code is subsequently entered, the USIM application 28 can request the monitor component 68 to discard the stored fingerprint and establish a new ME fingerprint from new measurements.

‘Brick’—Using NVRAM or one-time-programmable (OTP) fuses (such as eFuses), the UICC 56 can “brick” itself, i.e. disable itself (preferably permanently) so that it becomes unusable. In this case, the USIM application 28 may overwrite any sensitive stored information such as SUPI, MNO authentication parameters, etc. prior to triggering the disable operation. While this operation is preferably irreversible, this action may be considered for some applications in which a UICC can become compromised. Alternatively, the disabling of the UICC 56 can be temporary, e.g., with an odd number of OTP fuses programmed to indicate ‘bricked’ and an even number programmed to indicate “unbricked” (not disabled).

Hide (1) —The UICC 56/USIM application 28 could also choose a hiding strategy. For example, it could just record the fingerprint of the ME 4 for later analysis. The UICC 56/USIM application 28 could potentially disable some advanced features on a NO MATCH condition, or use later OTA communication with the MNO 8 without alerting the ME 4 to being identified as a NO MATCH.

Hide (2) —In an alternative ‘hide’ approach, the UICC 56 can contain two different subscriptions (e.g. IMSIs), with one subscription being used in the correct ME 4, and the other subscription being used if a NO MATCH has been detected. In this case, the UICC 56 will appear to be working correctly to the ME 4.

As noted above, instead of or in addition to the UICC 56 reacting to a measurement result indicating a fingerprint mismatch, the UICC 56 could also inform the HPLMN 8 about the situation and let the network 8 react to it. For example, the HPLMN 8 might temporarily block the subscription associated with the UICC 56, or throttle the subscription (e.g. reduce the available data rate, and/or reduce the available services) and potentially start an investigation related to the subscription. This could mean, e.g., contacting the subscriber and querying what has happened etc., or running remote diagnostics on the UICC 56/ME 4 (if available). In a scenario where the ME 4 has actually been tampered with, this signalling needs to be done in a covert way so that the now compromised ME 4 will not notice it, as otherwise the ME 4 might try to block this signalling to keep the HPLMN 8 from finding out that something suspicious is happening.

One way the UICC 56 could inform the HPLMN 8 without the ME 4 being able to detect it is by including information about the measurement in the SUCI sent to the HPLMN 8 as part of the 5G registration. The UICC 56 freshly generates the SUCI (concealed identifier) from the SUPI (permanent identifier) for each new 5G registration request. The process entails encrypting the Mobile Subscription Identification Number (MSIN) part of the SUPI (IMSI) with a key only obtainable by the HPLMN 8. In this way any entity on the communication path cannot know the actual subscription identifier, thus providing privacy for the subscriber, while the HPLMN 8 will be able to de-conceal the SUCI and thus obtain the corresponding SUPI. The SUCI is generated on the UICC 56 and thus the ME 4 does not get to see the content of the concealed part of the SUCI.

This concealed part of the data could also be utilised for concealing the information about the measurements done by the UICC 56. In practice, when the UICC 56 generates the SUCI from the SUPI, instead of just concealing the MSIN, the UICC 56 can also conceal information about the measurement results, for example by concatenating the MSIN with the measurement information and/or the result of the match/mismatch decision, and then conceal the result. This could be performed every time a SUCI is generated, i.e. even when there are no discrepancies in the measurements. This would make it even more difficult for the ME 4 to detect if the UICC 56 has noticed a problem with the fingerprint, as the length of the concealed part of the SUCI could be kept the same regardless of whether there is a positive or negative message from the monitor component 68.

Another channel for communications between the UICC 56 and HPLMN 8 in secret from the ME 4 could be based on the UICC OTA keys, which the HPLMN 8 typically uses for remotely managing the files on the UICC 56. However, this would be new signalling that could be detected by the ME 4, although the ME 4 will not be able to interpret the content of the messages. The UICC OTA keys could be used either by the UICC 56 to send encrypted data to the HPLMN 8, or used by the HPLMN 8 to fetch additional information from the UICC 56 based on information received in the concealed part of the SUCI discussed above.

There are also some other methods that can be used to send information about the ME fingerprinting status to the HPLMN 8. For example, the UICC 56/USIM application 28 can use proactive UICC commands to send an SMS message, open a browser at a given uniform resource locator (URL) (which allows the UICC 56 to embed information into the URL and its query parameters, although this is visible to the end user/ME 4), opening a data channel, etc. Regardless of the specific method, unless the ME 4 actively prevents the UICC 56 from communicating with the HPLMN 8, the UICC 56 can establish communication with its HPLMN 8.

The UICC 56 and home MNO 8 could also agree that any successful registration must be followed by an non-replayable acknowledgement by the UICC 56 (using some of the available channels). Thus, even if the SUCI cannot be used reliably as a covert channel (as it can be cached and reused by the ME 4), and all other communication channels are blocked by the ME 4, the absence of a positive match from the UICC 56 after network registration can itself be a signal of compromise.

If the UICC 56 ends up in a temporarily locked state, it may require unlocking by the HPLMN 8. In this case, the HPLMN 8 may require the ME 4 to supply measurement unit logs to determine if the abnormal measurements constitute an attack or not. This may also be combined with a user interaction (e.g. PIN/PUK) unlock.

Further details of the embodiments where the SUCI is used as a covert channel to signal a fingerprint match/mismatch to the network 8 are provided below. In the network 8, an Access and Mobility Function (AMF) delegates the actual authentication of the ME 4 to an Authentication Server Function (AUSF). Logically, the UDM is the first location in the network 8 that can decrypt the SUCI and obtain the subscriber's identity (SUPI), which is provided, along with authentication vectors, to the AUSF. Once authentication has been completed, the network has the subscription information, and can issue a session from a Session Management Function (SMF) and instantiate it at a User Plane Function (UPF).

On detecting a fingerprint mismatch, the UICC 56 can generate a valid-looking, but incorrect, SUCI that the AUSF can reject. The same applies to embodiments outlined above where the UICC 56 stores a second set of subscription credentials that are only to be used in the event of a fingerprint mismatch. The AUSF can reject the SUCI directly, as an authentication failure, or alternatively the AUSF could indicate to the UICC 56 that the registration is to continue so it looks valid for the ME 4, but that will not result in a valid session. In this case, the UICC 56 and MNO 8 could have agreed on a SUPI that indicates a status such as “deny session but pretend success” (note that this is slightly different to including an indication alongside the SUPI when the SUCI is used as a covert channel as outlined above). Another alternative is for the registration to result in a so-called “honeypot” session where the HPLMN is applying extra monitoring to the ME 4.

If a fingerprint match indicator is included in the SUCI (either as an extra field, or each subscriber UICC could be assigned two SUPIs, one that is used to indicate “all is ok”, and another SUPI that is used to indicate “match failed, device is suspect”).

In the case of a fingerprint mismatch, the MNO can perform any of: reject the authentication (AUSF failure); perform a “stealth failure” (i.e. the registration/negotiation appears to complete to the ME 4, but the base station (gNB) will still refuse further communication, and no session is created); allow authentication to complete, but mark the session as a “bad fingerprint”, which in turn could lead to the SMF changing the session parameters; the UPF could add additional filtering; and/or if there is a 5G identity delegation to external parties, this could be denied (i.e. the subscriber identity would not be available for other parties such as enterprises).

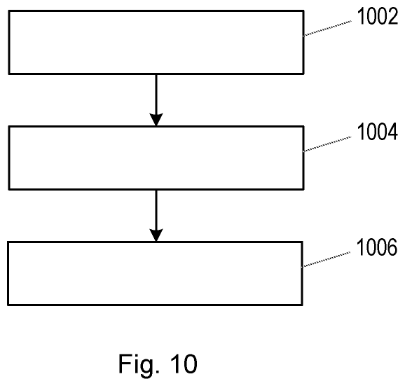

FIG. 10 is a flow chart illustrating a method of operating a UICC 56 according to various embodiments. In this method, the UICC 56 is located in a ME 4 that is referred to as the ‘host ME’, and the UICC 56 has available a fingerprint for a first ME, which may or may not be the host ME 4. The UICC 56 may perform the method in response to executing suitably formulated computer readable code. The computer readable code may be embodied or stored on a computer readable medium, such as a memory chip, optical disc, or other storage medium, including a UICC. The computer readable medium may be part of a computer program product.

The method in FIG. 10 can be performed in a number of different situations, including: when the UICC 56 is initialised in the host ME 4; continuously or periodically during operation of the UICC 56 in the host ME 4; prior to or during a network registration procedure in which the host ME 4 is to register to a network 8; prior to a user code being used to unlock functions of the UICC 56 in the host ME 4; when a concealed identifier is requested by the host ME 4; when authentication is requested from the UICC 56; and when a SUCI is requested by the host ME 4.

In step 1002, the UICC 56 measures one or more characteristics of the host ME 4. The characteristics can be measured by one or more probes in the UICC 56. The characteristics of the host ME 4 that can be measured can include any one or more of: electrical parameters, voltage parameters, communication parameters, signal levels, duty cycle lengths, one or more parameters of a clock signal provided by the host ME to the UICC, one or more electrical parameters of logical signals, one or more parameters related to a data link protocol, one or more parameters relating to a transport protocol, one or more parameters relating to an application selection protocol, an order of access to directories and/or files in a UICC master directory, an order of access to directories and/files in a USIM application directory, an order of commands, parameters of commands and/or timing information of commands issued by the host ME 4.

In step 1004, the UICC 56 determines if the characteristic measurements for the host ME 4 are consistent with a first ME fingerprint corresponding to a first ME 4.

In step 1006, the UICC 56 performs a first action if the characteristic measurements for the host ME 4 are inconsistent with the first ME fingerprint.

A number of different options are available for the first action. In some embodiments, the UICC 56 may be capable of performing several of the first actions listed below, in which case the UICC 56 can select a most appropriate first action to take in step 1006 if it is determined that the characteristic measurements for the host ME 4 are inconsistent with the first ME fingerprint. Alternatively, the UICC 56 may only be configured to perform one of the first actions listed below, in which case the UICC 56 performs that action in step 1006 if it is determined that the characteristic measurements for the host ME 4 are inconsistent with the first ME fingerprint.

The first action can be any of:
refraining from providing information to the host ME 4 that is required for the host ME 4 to register and/or authenticate to a network 8;
reject any user code (e.g. a PIN) input to the host ME 4 that is to unlock functions of the UICC 56 in the host ME 4;
activate a UICC 56 lockdown mode (e.g. requiring a PUK for the UICC 56 to be entered into the host ME 4);
activate the UICC 56 lockdown mode and delete or reset the first ME fingerprint;
refraining from providing a concealed identifier to the host ME 4;
refraining from providing a SUCI to the host ME 4;
providing, to the host ME 4, a modified concealed identifier that is to be sent to a home network 8.
   The modified concealed identifier can be derived from an identifier for a subscription associated with the UICC 56 and information indicating that characteristic measurements for the host ME 4 are inconsistent with the first ME fingerprint;
providing, to the host ME 4, a modified SUCI that is to be sent to a home network 8. The modified SUCI can be derived from a SUPI and information indicating that characteristic measurements for the host ME 4 are inconsistent with the first ME fingerprint;
sending, to the network 8, a notification that characteristic measurements for the host ME 4 are inconsistent with the first ME fingerprint;
deleting or overwriting subscription information stored in the UICC 56;
providing authentication information for a secondary subscription stored on the UICC 56 (e.g. where the UICC 56 stores a primary subscription that is to be used if the characteristic measurements of the host ME 4 are consistent with the first ME fingerprint, and a secondary subscription that is to be used if the characteristic measurements are inconsistent);
temporarily disabling operation of the UICC 56;
permanently disabling operation of the UICC 56; and
storing the characteristic measurements for the host ME 4 (in which case the UICC 56 may wait for some time before communicating the inconsistency to the network 8.

In some embodiments, the first ME fingerprint is derived from measurements of one or more characteristics of the first ME. Thus, in some embodiments, when the UICC 56 is hosted in the first ME, the method in the UICC 56 further comprises measuring one or more characteristics of the first ME, and determining the first ME fingerprint for the first ME from the measured characteristics of the first ME.

In some embodiments the first ME fingerprint comprises one or more statistical values. In these embodiments, step 1004 can comprise comparing the characteristic measurements for the host ME 4, and/or one or more statistical values derived from the characteristic measurements for the host ME 4, to the statistical values comprised in the first ME fingerprint.

In alternative embodiments, the first ME fingerprint comprises one or more model weights for a ML model. In these embodiments, step 1004 can comprise inputting the characteristic measurements for the host UE 4 into the ML model configured according to the one or more model weights, and determining if the characteristic measurements for the host ME 4 are consistent with a first ME fingerprint based on the output of the ML model.

In some embodiments, the method further comprises the UICC 56 performing a second action if it is found in step 1004 that the characteristic measurements for the host ME 4 are consistent with the first ME fingerprint.

The second action may be any one or more of: providing information to the host ME 4 that is required for the host ME 4 to register and/or authenticate to a network 8; unlocking functions of the UICC 56; providing authentication information for a primary subscription stored on the UICC 56; providing a concealed identifier to the host ME 4; and providing a SUCI to the host ME 4.

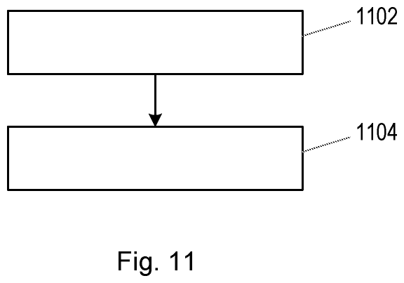

FIG. 11 is a flow chart illustrating another method of operating a UICC 56 according to various embodiments. In this method, the UICC 56 is located in a ME 4 that is referred to as the ‘first ME’, and in this method the UICC 56 determines a fingerprint for the first ME 4. The UICC 56 may perform the method in response to executing suitably formulated computer readable code. The computer readable code may be embodied or stored on a computer readable medium, such as a memory chip, optical disc, or other storage medium, including a UICC. The computer readable medium may be part of a computer program product.

In step 1102, the UICC 56 measures one or more characteristics of the first ME 4.

In step 1104, the UICC 56 determines a first ME fingerprint for the first ME 4 from the characteristic measurements.

In some embodiments, the first ME fingerprint comprises one or more statistical values, and step 1104 comprises analysing the characteristic measurements for the first ME 4 to determine one or more statistical values representative of the first ME 4. In some embodiments, the one or more statistical values comprise average and/or variance information for the one or more characteristics.

In alternative embodiments, the first ME fingerprint comprises one or more model weights for a ML model, and step 1104 comprises training or updating the ML model using the characteristic measurements for the first ME such that the trained or updated ML model is able to provide an output indicating if characteristic measurements that are input to the ML model are consistent with the first ME. In these embodiments, the first ME fingerprint is determined as one or more model weights of the trained or updated ML model.

In some embodiments, a UICC 56 can perform both the method shown in FIG. 10 and the method shown in FIG. 11.

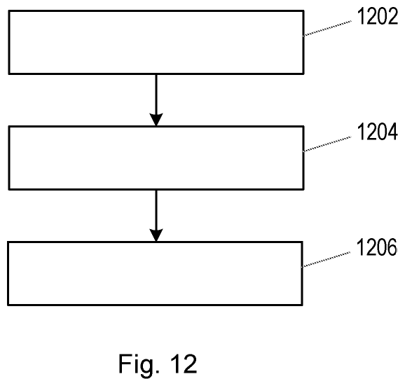

FIG. 12 is a flow chart illustrating a method of operating one or more network nodes in a communication network according to various embodiments. That is, each of the steps in FIG. 11 can be performed by the same network node, or different steps in FIG. 11 can be performed by two or more network nodes. The one or more network nodes can be or include a node in the radio access network (RAN), such as a base station (e.g. an eNB in Long Term Evolution (LTE) networks or a gNB in New Radio (NR)), and/or the one or more network nodes can be or include a node in the core network, such as a network node responsible for authentication of a ME 4 to the network. The one or more network nodes may perform the method in response to executing suitably formulated computer readable code. The computer readable code may be embodied or stored on a computer readable medium, such as a memory chip, optical disc, or other storage medium. The computer readable medium may be part of a computer program product.

In step 1202, the network node receives a first message from a host ME 4 that is registering and/or authenticating with, or is registered and/or authenticated with, the network 8.

In step 1204, the network node processes the first message to extract an indication of whether a UICC 56 in the host ME 4 considers that characteristic measurements for the host ME 4 are consistent with a first ME fingerprint corresponding to a first ME 4.

In step 1206, the network node performs an action based on the extracted indication.

In some embodiments, the first message is, or comprises, a concealed identifier or a SUCI. In these embodiments, the extracted indication can comprise information encoded in the concealed identifier or the SUCI indicating whether characteristics of the host ME 4 are consistent with the first ME fingerprint.

In alternative embodiments, the first message can be, or comprise, information encrypted using OTA keys previously provided to the UICC 56 by the network 8.

In alternative embodiments, the first message can be a SMS message.

In some embodiments, if the indication indicates that the UICC considers that characteristic measurements for the host ME are inconsistent with the first ME fingerprint corresponding to the first ME, the network node can further perform any one or more of: blocking or preventing access to the network 8 by the host ME 4; reducing or restricting a service provided by the network 8 to the host ME 4; and sending a second message to a subscriber associated with the UICC 56 to query the inconsistency.

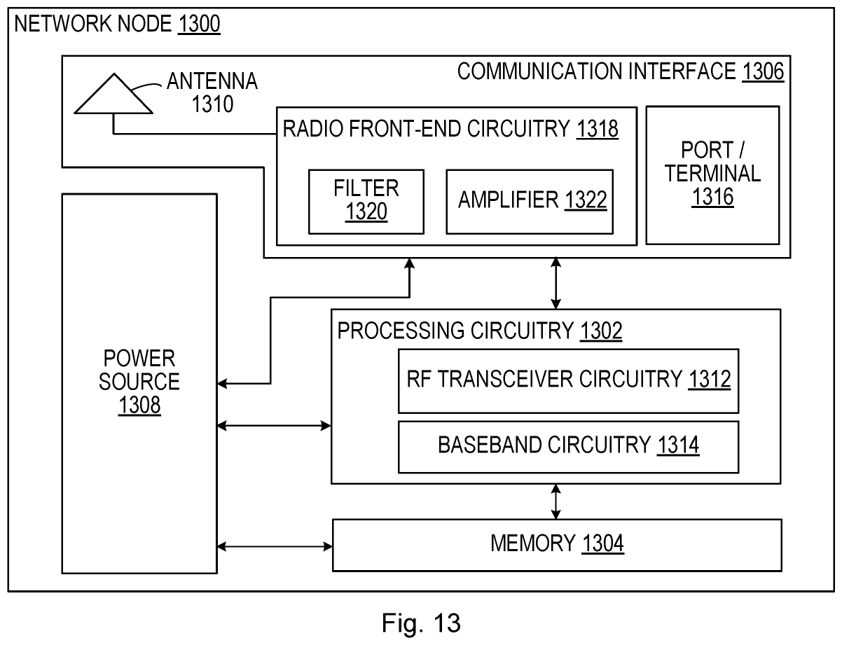

FIG. 13 shows a network node 1300 in accordance with some embodiments that can be used to implement the methods described above. As used herein, network node refers to equipment capable, configured, arranged and/or operable to communicate directly or indirectly with a UE and/or with other network nodes or equipment, in a telecommunication network. Examples of network nodes include, but are not limited to, access network nodes such as access points (APs) (e.g. radio access points), base stations (BSs) (e.g. radio base stations, Node Bs, evolved Node Bs (eNBs) and NR NodeBs (gNBs)). Other examples of network nodes include, but are not limited to, core network nodes such as nodes that include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The network node 1300 includes processing circuitry 1302, a memory 1304, a communication interface 1306, and a power source 1308, and/or any other component, or any combination thereof. The network node 1300 may be composed of multiple physically separate components (e.g. a NodeB component and a RNC component, or a BTS component and a BSC component, etc.), which may each have their own respective components. In certain scenarios in which the network node 1300 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g. separate memory 1304 for different RATs) and some components may be reused (e.g. a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality. For example, the processing circuitry 1302 may be configured to cause the network node to perform part or all of the method as described with reference to FIG. 12.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signalling and/or data between network nodes, the access network, the core network, and/or a UE. As illustrated, the communication interface 1306 comprises port(s)/terminal(s) 1316 to send and receive data, for example to and from a network over a wired connection.

In embodiments where the network node 1300 is an access network node, the communication interface 1306 also includes radio front-end circuitry 1318 that may be coupled to, or in certain embodiments a part of, the antenna 1310. In embodiments where the network node 1300 is a core network node, the core network node may not include radio front-end circuitry 1318 and antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the access network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g. at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g. the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

Although the computing devices described herein (e.g. MEs, UICCs, UEs, network nodes, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

ABBREVIATIONS
At least some of the following abbreviations may be used in this disclosure. If there is an inconsistency
between abbreviations, preference should be given to how it is used above. If listed multiple
times below, the first listing should be preferred over any subsequent listing(s).

| | | | |
|---|---|---|---|
| AKMA | Authentication and Key Management for | URL | Uniform Resource Locator |
| | Applications | USIM | Universal Subscriber Identity Module |
| APDU | Application Protocol Data Unit | | |
| CK | Confidentiality Key | 3GPP | 3rd Generation Partnership Project |
| EF | Elementary File | 5G | 5th Generation |
| eSIM | embedded Subscriber Identity Module | 6G | 6th Generation |
| FDR | Frequency Domain Reflectometry | ABS | Almost Blank Subframe |
| GBA | Generic Bootstrapping Architecture | ARQ | Automatic Repeat Request |
| HPLMN | Home Public Land Mobile Network | AWGN | Additive White Gaussian Noise |
| HW | Hardware | BCCH | Broadcast Control Channel |
| IK | Integrity Key | BCH | Broadcast Channel |
| IMEI | International Mobile Equipment Identity | CA | Carrier Aggregation |
| IMSI | International Mobile Subscription Identity | CC | Carrier Component |
| iSIM | integrated Subscriber Identity Module | CCCH SDU | Common Control Channel SDU |
| ME | Mobile Equipment | CDMA | Code Division Multiplexing Access |
| MF | Master File | CGI | Cell Global Identifier |
| MNO | Mobile Network Operator | CIR | Channel Impulse Response |
| NVM | Non-volatile Memory | CP | Cyclic Prefix |
| NVRAM | Non-volatile Random Access Memory | CPICH | Common Pilot Channel |
| OS | Operating System | CPICH | Ec/No CPICH Received energy per chip |
| OWF | One-way Function | | divided by the power density in the band |
| PHY | Physical | CQI | Channel Quality information |
| PIN | Personal Identification Number | C-RNTI | Cell RNTI |
| PUF | Physically Unclonable Function | CSI | Channel State Information |
| PUK | Personal Unlocking Key | DCCH | Dedicated Control Channel |
| RAND | Random challenge | DL | Downlink |
| RX | Receiving/Receiver | DM | Demodulation |
| SIM | Subscriber Identity Module | DMRS | Demodulation Reference Signal |
| SUCI | Subscription Concealed Identity | DRX | Discontinuous Reception |
| SUPI | Subscription Permanent Identity | DTX | Discontinuous Transmission |
| SW | Software | DTCH | Dedicated Traffic Channel |
| TEE | Trusted Execution Environment | DUT | Device Under Test |
| TPM | Trusted Platform Module | E-CID | Enhanced Cell-ID (positioning method) |
| TDR | Time Domain Reflectometry | eMBMS | evolved Multimedia Broadcast Multicast |
| TX | Transmission/Transmitter | | Services |
| UICC | Universal Integrated Circuit Card | E-SMLC | Evolved-Serving Mobile Location Centre |
| ECGI | Evolved CGI | PCell | Primary Cell |
| eNB | E-UTRAN NodeB | PCFICH | Physical Control Format Indicator Channel |
| ePDCCH | Enhanced Physical Downlink Control | PDCCH | Physical Downlink Control Channel |
| | Channel | PDCP | Packet Data Convergence Protocol |
| E-SMLC | Evolved Serving Mobile Location Center | PDP | Profile Delay Profile |
| E-UTRA | Evolved UTRA | PDSCH | Physical Downlink Shared Channel |
| E-UTRAN | Evolved UTRAN | PGW | Packet Gateway |
| FDD | Frequency Division Duplex | PHICH | Physical Hybrid-ARQ Indicator Channel |
| FFS | For Further Study | PLMN | Public Land Mobile Network |
| gNB | Base station in NR | PMI | Precoder Matrix Indicator |
| GNSS | Global Navigation Satellite System | PRACH | Physical Random Access Channel |
| HARQ | Hybrid Automatic Repeat Request | PRS | Positioning Reference Signal |
| | HO Handover | PSS | Primary Synchronization Signal |
| HSPA | High Speed Packet Access | PUCCH | Physical Uplink Control Channel |
| HRPD | High Rate Packet Data | PUSCH | Physical Uplink Shared Channel |
| LOS | Line of Sight | RACH | Random Access Channel |
| LPP | LTE Positioning Protocol | QAM | Quadrature Amplitude Modulation |
| LTE | Long-Term Evolution | RAN | Radio Access Network |
| MAC | Medium Access Control | RAT | Radio Access Technology |
| MAC | Message Authentication Code | RLC | Radio Link Control |
| MBSFN | Multimedia Broadcast multicast service | RLM | Radio Link Management |
| | Single Frequency Network | RNC | Radio Network Controller |
| MBSFN ABS | MBSFN Almost Blank Subframe | RNTI | Radio Network Temporary Identifier |
| MDT | Minimization of Drive Tests | RRC | Radio Resource Control |
| MIB | Master Information Block | RRM | Radio Resource Management |
| MME | Mobility Management Entity | RS | Reference Signal |
| MSC | Mobile Switching Center | RSCP | Received Signal Code Power |
| NPDCCH | Narrowband Physical Downlink Control | RSRP | Reference Symbol Received Power OR |
| | Channel | | Reference Signal Received Power |
| NR | New Radio | RSRQ | Reference Signal Received Quality OR |
| OCNG | OFDMA Channel Noise Generator | | Reference Symbol Received Quality |
| OFDM | Orthogonal Frequency Division Multiplexing | RSSI | Received Signal Strength Indicator |
| OFDMA | Orthogonal Frequency Division Multiple | RSTD | Reference Signal Time Difference |
| | Access | SCH | Synchronization Channel |
| OSS | Operations Support System | SCell | Secondary Cell |
| OTDOA | Observed Time Difference of Arrival | SDAP | Service Data Adaptation Protocol |
| O&M | Operation and Maintenance | SDU | Service Data Unit |
| PBCH | Physical Broadcast Channel | SFN | System Frame Number |
| P-CCPCH | Primary Common Control Physical Channel | SGW | Serving Gateway |
| SI | System Information | UE | User Equipment |
| SIB | System Information Block | UL | Uplink |
| SNR | Signal to Noise Ratio | UMTS | Universal Mobile Telecommunications |
| SON | Self Optimized Network | | System |
| SS | Synchronization Signal | USIM | Universal Subscriber Identity Module |
| SSS | Secondary Synchronization Signal | UTDOA | Uplink Time Difference of Arrival |
| TDD | Time Division Duplex | UTRA | UMTS Terrestrial Radio Access |
| TDOA | Time Difference of Arrival | UTRAN | UTRA Network |
| TOA | Time of Arrival | WCDMA | Wide CDMA |
| TSS | Tertiary Synchronization Signal | WLAN | Wide Local Area Network |
| TTI | Transmission Time Interval | | |

1-71. (canceled)

72. A method of operating a universal integrated circuit card (UICC) in a host mobile equipment (ME), the method comprising:
measuring one or more characteristics of the host ME, thereby obtaining characteristic measurements for the host ME;
determining if the characteristic measurements for the host ME are consistent with a first ME fingerprint corresponding to a first ME; and
as a result of determining that the characteristic measurements for the host ME are inconsistent with the first ME fingerprint, performing a first action, wherein the one or more characteristics comprise:
electrical parameters,
voltage parameters,
communication parameters,
signal levels,
duty cycle lengths,
one or more parameters of a clock signal provided by a ME hosting the UICC to the UICC,
one or more electrical parameters of logical signals,
one or more parameters related to a data link protocol,
one or more parameters relating to a transport protocol,
one or more parameters relating to an application selection protocol,
an order of commands, and/or
parameters of commands and/or timing information of commands issued by the ME hosting the UICC.

73. The method of claim 72, wherein the method is performed:
when the UICC is initialized in the host ME;
continuously or periodically during operation of the UICC in the host ME;
prior to or during a network registration procedure in which the host ME is to register to a network;
prior to a user code being used to unlock functions of the UICC in the host ME;
when a concealed identifier is requested by the host ME;
when authentication is requested from the UICC; or
when a Subscription Concealed Identifier, SUCI, is requested by the host ME.

74. The method of claim 72, wherein
the UICC is hosted in the first ME, and
the method further comprises:
measuring one or more characteristics of the first ME; and
determining the first ME fingerprint for the first ME from the measured characteristics of the first ME.

75. A method of operating one or more network nodes in a network, the method comprising:
receiving a first message from a host mobile equipment (ME) that is registering and/or authenticating with, or is registered and/or authenticated with, the network;
processing the first message to extract an indication of whether a universal integrated circuit card (UICC) in the host ME considers that characteristic measurements for the host ME are consistent with a first ME fingerprint corresponding to a first ME; and
performing an action based on the extracted indication, wherein
the measured characteristics comprise:
electrical parameters,
voltage parameters,
communication parameters,
signal levels,
duty cycle lengths,
one or more parameters of a clock signal provided by a ME hosting the UICC to the UICC,
one or more electrical parameters of logical signals,
one or more parameters related to a data link protocol,
one or more parameters relating to a transport protocol,
one or more parameters relating to an application selection protocol,
an order of commands, and/or
parameters of commands and/or timing information of commands issued by the ME hosting the UICC.

76. The method of claim 75, wherein the first message is, or comprises, information encrypted using over the air keys previously provided to the UICC by the network.

77. The method of claim 75, wherein the first message is a short message service message.

78. The method of claim 75, wherein, if the indication indicates that the UICC considers that characteristic measurements for the host ME are inconsistent with the first ME fingerprint corresponding to the first ME, the method further comprises any one or more of:
blocking or preventing access to the network by the host ME;
reducing or restricting a service provided by the network to the host ME; and
sending a second message to a subscriber associated with the UICC to query the inconsistency.

79. The method of claim 75, wherein the first message is, or comprises, a concealed identifier or a Subscription Concealed Identifier.

80. A universal integrated circuit card (UICC) for use in a host mobile equipment (ME), wherein the UICC comprises a processor and a memory, the memory containing instructions executable by the processor wherein the UICC is operative to:
measure one or more characteristics of the host ME;
determine if the characteristic measurements for the host ME are consistent with a first ME fingerprint corresponding to a first ME; and
perform a first action if the characteristic measurements for the host ME are inconsistent with the first ME fingerprint, wherein the one or more characteristics comprise any one or more of:
electrical parameters, voltage parameters, communication parameters, signal levels, duty cycle lengths, one or more parameters of a clock signal provided by a ME hosting the UICC to the UICC, one or more electrical parameters of logical signals, one or more parameters related to a data link protocol, one or more parameters relating to a transport protocol, one or more parameters relating to an application selection protocol, an order of commands, parameters of commands and/or timing information of commands issued by the ME hosting the UICC.

81. The UICC of claim 80, wherein the UICC is configured to measure the one or more characteristics:
when the UICC is initialized in the host ME;
continuously or periodically during operation of the UICC in the host ME;
prior to or during a network registration procedure in which the host ME is to register to a network;
prior to a user code being used to unlock functions of the UICC in the host ME;
when a concealed identifier is requested by the host ME;
when authentication is requested from the UICC; or
when a Subscription Concealed Identifier, SUCI, is requested by the host ME.

82. The UICC of claim 80, wherein the first ME fingerprint was derived from measurements of one or more characteristics of the first ME.

83. The UICC of claim 80, wherein the first ME fingerprint comprises one or more statistical values, and wherein the UICC is configured to determine if the characteristic measurements for the host ME are consistent with a first ME fingerprint by comparing the characteristic measurements for the host ME, and/or one or more statistical values derived from the characteristic measurements for the host ME, to the statistical values comprised in the first ME fingerprint.

84. The UICC of claim 80, wherein the first ME fingerprint comprises one or more model weights for a machine learning (ML) model, and wherein the UICC is configured to determine if the characteristic measurements for the host ME are consistent with a first ME fingerprint by inputting the characteristic measurements for the host UE into the ML model configured according to the one or more model weights and determining if the characteristic measurements for the host ME are consistent with a first ME fingerprint based on the output of the ML model.

85. The UICC of claim 80, wherein, the UICC is further configured to:
when the UICC is hosted in the first ME, measure one or more characteristics of the first ME; and
determine the first ME fingerprint for the first ME from the measured characteristics of the first ME.

86. The UICC of claim 80, wherein perform the first action comprises any one or more of:
refrain from providing information to the host ME that is required for the host ME to register and/or authenticate to a network;
reject any user code input to the host ME that is to unlock functions of the UICC in the host ME;
activate a UICC lockdown mode;
activate the UICC lockdown mode and delete or reset the first ME fingerprint;
refrain from providing a concealed identifier to the host ME;
refrain from providing a Subscription Concealed Identifier, SUCI, to the host ME;
provide, to the host ME, a modified concealed identifier that is to be sent to a home network, wherein the modified concealed identifier is derived from an identifier for a subscription associated with the UICC and information indicating that characteristic measurements for the host ME are inconsistent with the first ME fingerprint;
provide, to the host ME, a modified SUCI that is to be sent to a home network, wherein the modified SUCI is derived from a Subscription Permanent Identifier, SUPI, and information indicating that characteristic measurements for the host ME are inconsistent with the first ME fingerprint;
send, to the network, a notification that characteristic measurements for the host ME are inconsistent with the first ME fingerprint;
delete or overwrite subscription information stored in the UICC;
provide authentication information for a secondary subscription stored on the UICC;
temporarily disable operation of the UICC;
permanently disable operation of the UICC; and
store the characteristic measurements for the host ME.

87. The UICC of claim 80, wherein the UICC is further configured to:
perform a second action if the characteristic measurements for the host ME are consistent with the first ME fingerprint, wherein the second action comprises any one or more of:
provide information to the host ME that is required for the host ME to register and/or authenticate to a network;
unlock functions of the UICC;
provide authentication information for a primary subscription stored on the UICC;
provide a concealed identifier to the host ME; and
provide a Subscription Concealed Identifier, SUCI, to the host ME.

88. The UICC of claim 80, wherein the characteristics are measured by one or more probes in the UICC.

89. A universal integrated circuit card (UICC) for use in a first mobile equipment (ME), wherein the UICC comprises a processor and a memory, the memory containing instructions executable by the processor whereby the UICC is operative to:
measure one or more characteristics of the first ME; and
determine a first ME fingerprint for the first ME from the characteristic measurements, wherein the one or more characteristics comprise any one or more of:
electrical parameters, voltage parameters, communication parameters, signal levels, duty cycle lengths, one or more parameters of a clock signal provided by a ME hosting the UICC to the UICC, one or more electrical parameters of logical signals, one or more parameters related to a data link protocol, one or more parameters relating to a transport protocol, one or more parameters relating to an application selection protocol, an order of commands, parameters of commands and/or timing information of commands issued by the ME hosting the UICC.

90. The UICC of claim 89, wherein
the first ME fingerprint comprises one or more statistical values, and
the UICC is configured to determine the first ME fingerprint by analyzing the characteristic measurements for the first ME to determine one or more statistical values representative of the first ME.

91. The UICC of claim 89, wherein
the first ME fingerprint comprises one or more model weights for a machine learning (ML) model, and
the UICC is configured to determine the first ME fingerprint by training or updating the ML model using the characteristic measurements for the first ME such that the trained or updated ML model is able to provide an output indicating if characteristic measurements that are input to the ML model are consistent with the first ME, and determining the first ME fingerprint as one or more model weights of the trained or updated ML model.
